(19) United States
(12) Patent Application Publication
(10) Pub. No.: US 2023/0290197 A1
(43) Pub. Date: Sep. 14, 2023

(54) VEHICLE AND VEHICLE CONTROL DEVICE

(71) Applicant: Panasonic Intellectual Property Management Co., Ltd., Osaka (JP)

(72) Inventors: Tsuyoshi NISHIO, Chiba (JP); Makoto HINATA, Kanagawa (JP); Masahiro ANEZAKI, Kanagawa (JP); Hajime HOMMA, Kanagawa (JP); Naoki USUI, Osaka (JP); Yuki NISHIDA, Kanagawa (JP); Takuma MASUDA, Kanagawa (JP)

(73) Assignee: Panasonic Intellectual Property Management Co., Ltd., Osaka (JP)

(21) Appl. No.: 18/199,510

(22) Filed: May 19, 2023

Related U.S. Application Data
(63) Continuation of application No. PCT/JP2021/036576, filed on Oct. 4, 2021.

(30) Foreign Application Priority Data
Nov. 30, 2020 (JP) 2020-199003
Dec. 9, 2020 (JP) 2020-203881
Dec. 9, 2020 (JP) 2020-204613

(51) Int. Cl. G07C 5/08; H04N 7/18; H04N 23/90; G06V 20/58; G06V 20/59; G06V 20/52

(52) U.S. Cl. CPC G07C 5/0825; H04N 7/188; H04N 23/90; G06V 20/58; G06V 20/59; G06V 20/52

(57) ABSTRACT

A vehicle according to the present disclosure includes a first wheel, a second wheel, a body coupled to the first and second wheels and movable by the first and second wheels, a first imaging circuit configured to capture an image of exterior of the vehicle, and a processor. The processor is configured to: set a monitoring target based on a captured image; start, when a monitoring start condition is met, a monitoring process of determining whether the monitoring target belongs to a monitoring range based on a captured image by the first imaging circuit; and terminate, when a monitoring end condition is met, the monitoring process, the monitoring start condition or the monitoring end condition including a condition related to an operation of the vehicle.

### CROSS-REFERENCE TO RELATED APPLICATIONS

This application is a continuation of International Application No. PCT/JP2021/036576, filed on Oct. 4, 2021 which claims the benefit of priority of the prior Japanese Patent Application No. 2020-199003, filed on Nov. 30, 2020, Japanese Patent Application No. 2020-203881, filed on Dec. 9, 2020 and Japanese Patent Application No. 2020-204613, filed on Dec. 9, 2020, the entire contents of which are incorporated herein by reference.

### FIELD

Embodiments described herein relate generally to a vehicle and a vehicle control device.

### BACKGROUND

Conventionally, technology has been disclosed which sets search criteria for a person to be searched for in a facility, identifies a person who is likely to be the person to be searched for, based on the search criteria, and monitors the identified person (see, for example, Japanese Patent Application Laid-open No. 2016-201758).

The present disclosure has been made in consideration of the above, and an object of the present disclosure is to appropriately control the start or end of a monitoring process in a vehicle.

### SUMMARY

A vehicle according to an embodiment of the present disclosure includes: a first wheel; a second wheel; a body coupled to the first wheel and the second wheel, the body being movable by the first wheel and the second wheel; a first imaging circuit configured to capture an image of exterior of the vehicle; and a processor. The processor is configured to: set a monitoring target; start, when a monitoring start condition is met, a monitoring process of determining whether the monitoring target belongs to a monitoring range based on a captured image by the first imaging circuit; and terminate, when a monitoring end condition is met, the monitoring process, the monitoring start condition or the monitoring end condition including a condition related to an operation of the vehicle.

### BRIEF DESCRIPTION OF THE DRAWINGS

FIG. 1 is a plan view schematically illustrating a vehicle according to the present embodiment;

FIG. 2 is a diagram illustrating an exemplary hardware configuration of a vehicle control device according to the present embodiment;

FIG. 3 is a diagram illustrating an exemplary functional configuration of the vehicle control device;

FIG. 4 is a diagram illustrating an example of a monitoring range;

FIG. 5 is a flowchart illustrating a monitoring range setting process;

FIG. 6 is a flowchart illustrating a manual monitoring target setting process;

FIG. 7 is a flowchart illustrating a learning-based monitoring target setting process;

FIG. 8 is a flowchart illustrating a control procedure of a monitoring process;

FIG. 9 is a diagram illustrating an overall configuration of a vehicle according to a second embodiment;

FIG. 10 is a diagram illustrating a configuration of an illumination circuit in a cabin according to the second embodiment;

FIG. 11 is a diagram illustrating a configuration of an imaging circuit and the illumination circuit in the second embodiment;

FIG. 12 is a diagram illustrating a hardware configuration of a vehicle control device in the second embodiment;

FIG. 13 is a diagram illustrating a partial functional configuration of the vehicle control device in the second embodiment;

FIG. 14 is a diagram illustrating the positions of image acquisition areas in the whole image in the second embodiment;

FIG. 15 is a diagram illustrating spatial changes of a plurality of light emitters in accordance with a plurality of timings in the second embodiment;

FIGS. 16A to 16C are diagrams illustrating temporal changes of a plurality of light emitters in accordance with a plurality of timings in the second embodiment;

FIG. 17 is a diagram illustrating a plurality of divided regions in the image acquisition area in the second embodiment;

FIG. 18 is a diagram illustrating a process of determining the luminance of a light emitter in the second embodiment;

FIG. 19 is a flowchart illustrating the operation of the vehicle according to the second embodiment;

FIG. 20 is a flowchart illustrating the operation of the vehicle according to the second embodiment;

FIG. 21 is a diagram illustrating control of a plurality of light emitters in accordance with an image of an image acquisition area and map information in a first modification of the second embodiment;

FIG. 22 is a flowchart illustrating the operation of the vehicle according to the first modification of the second embodiment;

FIG. 23 is a flowchart illustrating the operation of the vehicle according to a second modification of the second embodiment;

FIGS. 24A and 24B are schematic diagrams illustrating an exemplary vehicle equipped with a communication control device according to a third embodiment;

FIGS. 25A and 25B are diagrams illustrating an exemplary hardware configuration of the communication control device according to the third embodiment;

FIG. 26 is a diagram illustrating an exemplary functional configuration of the communication control device according to the third embodiment;

FIGS. 27A and 27B are diagrams illustrating icons, a seating chart, and seat data in a memory of the communication control device according to the third embodiment;

FIG. 28 is a flowchart illustrating an exemplary transmission process by the communication control device according to the third embodiment;

FIGS. 29A to 29E are diagrams illustrating exemplary display on a display device in the transmission process by the communication control device according to the third embodiment;

FIGS. 30A to 30D are diagrams illustrating exemplary display on the display device in the transmission process by the communication control device according to the third embodiment;

FIGS. 31A to 31C are diagrams illustrating exemplary display on the display device in the transmission process by the communication control device according to the third embodiment;

FIG. 32 is a flowchart illustrating an exemplary reception process by the communication control device according to the third embodiment;

FIGS. 33A and 33B are diagrams illustrating exemplary display on the display device in the reception process by the communication control device according to the third embodiment;

FIG. 34 is a flowchart illustrating an exemplary reply process by the communication control device according to the third embodiment;

FIGS. 35A to 35C are diagrams illustrating exemplary display on the display device in the replay process by the communication control device according to the third embodiment;

FIGS. 36A to 36D are diagrams illustrating exemplary display on the display device in the reply process by the communication control device according to the third embodiment; and

FIGS. 37A and 37B are diagrams illustrating exemplary indication of a light-emitting device in a light emitting process by the communication control device according to the third embodiment.

### DETAILED DESCRIPTION

Embodiments of a vehicle and a vehicle control device according to the present disclosure will be described below with reference to the drawings.

### First Embodiment

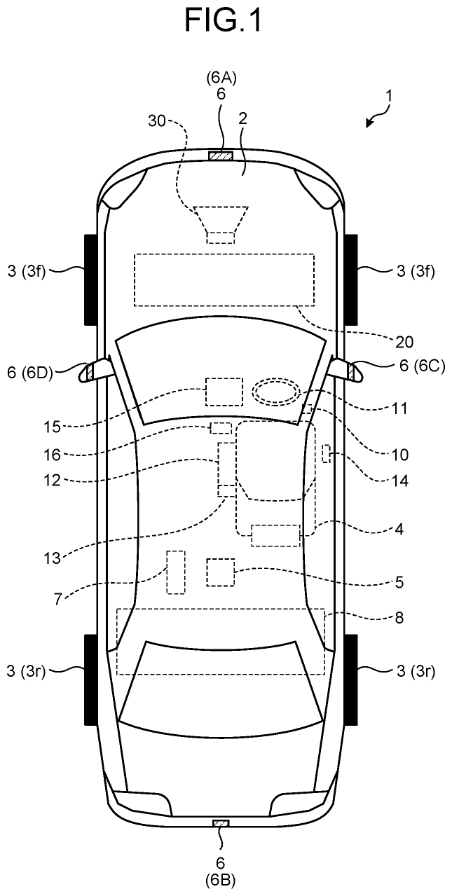

FIG. 1 is a plan view schematically illustrating a vehicle 1 according to the present embodiment. The vehicle 1 includes a body 2 and two pairs of wheels 3 (a pair of front tires 3f and a pair of rear tires 3r) arranged at the front and rear of the body 2.

The vehicle 1 can run on two pairs of wheels 3 arranged along a predetermined direction. In this case, the predetermined direction in which two pairs of wheels 3 are arranged is the direction in which the vehicle 1 moves, and the vehicle 1 can move forward or backward, for example, by shifting the gear.

The vehicle 1 also includes a vehicle drive unit 5, an exterior imaging circuit 6, and an exterior speaker 30. The exterior imaging circuit 6 is an example of the first imaging circuit.

The vehicle drive unit 5 is a drive device mounted on the vehicle 1. The vehicle drive unit 5 is, for example, an engine, a motor, or a drive unit for the wheels 3.

The exterior imaging circuit 6 is a camera that captures images of the exterior of the vehicle. An exterior imaging circuit 6A is provided at a front portion of the vehicle 1. The exterior imaging circuit 6A captures an image of the front of the vehicle 1 and generates a captured image. An exterior imaging circuit 6B is provided at a rear portion of the vehicle 1. The exterior imaging circuit 6B captures an image of the rear of the vehicle 1 and generates a captured image. An exterior imaging circuit 6C and an exterior imaging circuit 6D are provided, for example, around the door mirrors of the vehicle 1. The exterior imaging circuit 6C and the exterior imaging circuit 6D capture images of the sides of the vehicle 1 and generate captured images.

In the present embodiment, the manner in which a plurality of exterior imaging circuits 6 (exterior imaging circuits 6A to 6D) are provided on the body 2 of the vehicle 1 is described by way of an example. These exterior imaging circuits 6 are arranged at positions where they can capture images of the outside of the body 2.

The exterior speaker 30 is connected to a vehicle control device 20 and outputs sound in accordance with an audio signal output from the vehicle control device 20. The exterior speaker 30 is provided outside the cabin of the vehicle 1, for example, in the engine room. The exterior speaker 30 outputs sound to the outside of the vehicle 1.

A seat 4 on which the driver who is the user of the vehicle 1 is seated is provided in the cabin of the vehicle 1. In other words, the seat 4 is the driver's seat. The driver seated in the seat 4 can drive the vehicle 1 by operating a steering wheel 11 or operating a not-illustrated accelerator pedal or brake pedal.

An interior imaging circuit 7, an engine switch 10, a shift lever 12, a parking brake 13, a door lock device 14, an in-vehicle display device 15, a human detection sensor 16, and the like are also provided in the cabin of the vehicle 1.

The interior imaging circuit 7 is an example of the second imaging circuit. The interior imaging circuit 7 is a camera that captures an image of the interior of the vehicle. The interior imaging circuit 7 is provided in the cabin. The interior imaging circuit 7 captures, for example, an image around a rear seat 8 on which a passenger is seated. The interior imaging circuit 7 captures an image around the rear seat 8 of the vehicle 1 and generates a captured image.

The engine switch 10 is a switch that the driver operates to start the engine of the vehicle 1. The engine switch 10 is sometimes referred to as ignition switch. The vehicle 1 is brought into an engine started or stopped state through operation of the engine switch 10 by the driver. Further, for example, power supply to an electronic device mounted on the vehicle 1 is controlled through operation of the engine switch 10.

The shift lever 12 is a lever that the driver operates to change shift positions. The range of movement of the shift lever 12 includes, for example, a parking position, a reverse position, a neutral position, and a drive position.

With the shift lever 12 in the parking position, the power of the engine of the vehicle 1 is not transmitted to the wheels 3, which is called a parking state. With the shift lever 12 in the reverse position, the vehicle 1 is ready to move backward. With the shift lever 12 in the drive position, the vehicle 1 is ready to move forward.

The parking brake 13 is one of the braking mechanisms of the vehicle 1. The parking brake 13 is a manual control mechanism that allows the driver to manually stop the movement of the vehicle 1. With the parking brake 13 being applied, the movement of the vehicle 1 is stopped, which is the parking state. With the parking brake 13 being released, the vehicle 1 is ready to move.

The door lock device 14 is a device that switches the door of the vehicle 1 to a locked state or an unlocked state. For example, the door of the vehicle 1 can be switched to a locked state or an unlocked state by a vehicle key or the like from outside the vehicle 1.

The in-vehicle display device 15 is an example of the display device. The in-vehicle display device 15 has an image display function as well as audio output and input functions and the like. The image display function is, for example, a liquid crystal display (LCD), an organic electro-luminescent display (GELD), or the like. The audio output function is, for example, a speaker for the interior of the vehicle. The in-vehicle display device 15 is configured as a touch panel having a function to accept an operation input by the user. The in-vehicle display device 15 may further include a switch that accepts an operation input by the user.

The in-vehicle display device 15 may include a navigation device having a location information acquisition function and a route search function using map information.

The human detection sensor 16 is a sensor that detects the presence or absence of a person in the inside of the body 2. The human detection sensor 16 is, for example, an infrared sensor, an image analysis system for captured images, or a weight-based seating sensor.

The vehicle 1 is equipped with a communication device, a device to detect opening and closing states of the door of the vehicle 1, and a device to detect a state of ignition, which are not illustrated in FIG. 1.

In the present embodiment, the vehicle control device 20 is mounted on the vehicle 1. The vehicle control device 20 is a device that can be mounted on the vehicle 1. The vehicle control device 20 sets a monitoring range and a monitoring target and determines whether the monitoring target has deviated from the monitoring range. Here, the monitoring target is, for example, a child riding in the vehicle 1. The vehicle control device 20 is, for example, an electronic control unit (ECU) or an on-board unit (OBU) installed in the inside of the vehicle 1. Alternatively, the vehicle control device 20 may be an external device installed near the dashboard of the vehicle 1.

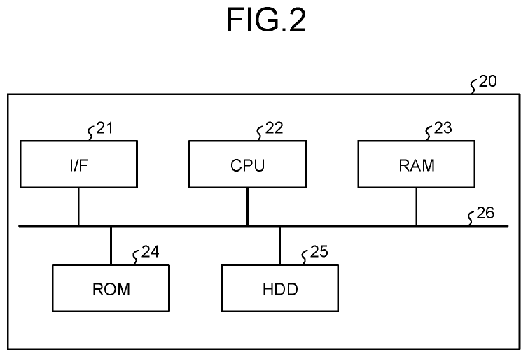

A hardware configuration of the vehicle control device 20 will now be described. FIG. 2 is a diagram illustrating an exemplary hardware configuration of the vehicle control device 20 according to the present embodiment. As illustrated in FIG. 2, the vehicle control device 20 includes an interface (I/F) 21, a CPU 22, a RAM 23, a ROM 24, and a hard disk drive (HDD) 25. The interface 21, the CPU 22, the RAM 23, the ROM 24, and the HDD 25 are connected through a bus 26.

The interface 21 is a variety of interfaces such as communication interface, image interfaces, audio interface, display interface, and input interface.

The HDD 25 stores a variety of information. For example, the HDD 25 stores a captured image acquired from the exterior imaging circuit 6 and the interior imaging circuit 7.

The CPU 22 executes a computer program stored in the ROM 24 or the HDD 25 to execute a variety of processes. The CPU 22 is an example of a processor.

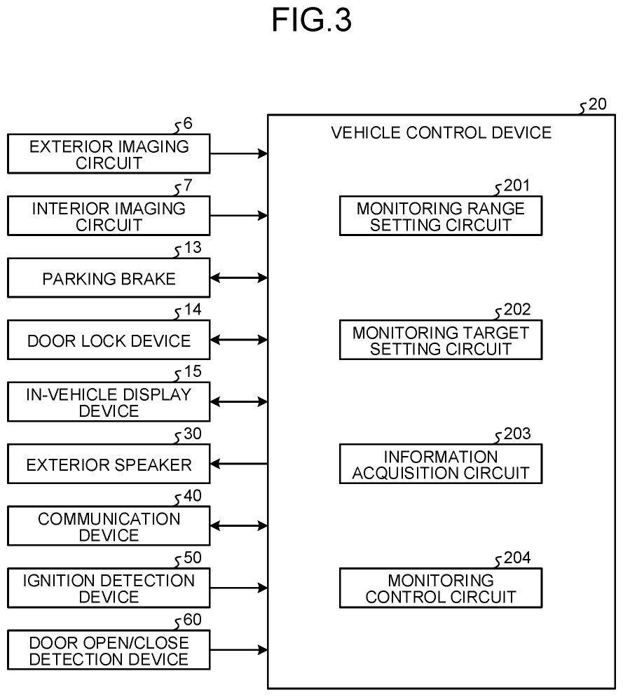

FIG. 3 is a diagram illustrating an exemplary functional configuration of the vehicle control device 20. The computer program executed by the vehicle control device 20 has a module structure including a monitoring range setting circuit 201, a monitoring target setting circuit 202, an information acquisition circuit 203, and a monitoring control circuit 204 illustrated in FIG. 3. As the actual hardware, the CPU 22 reads the computer program from a storage device such as the ROM 24 or HDD 25 and executes the computer program, so that the above units are loaded onto a main storage device such as the RAM 23, and the monitoring range setting circuit 201, the monitoring target setting circuit 202, the information acquisition circuit 203, and the monitoring control circuit 204 are generated on the main storage device.

The vehicle control device 20 is connected to the exterior imaging circuit 6, the interior imaging circuit 7, the parking brake 13, the door lock device 14, the in-vehicle display device 15, the exterior speaker 30, a communication device 40, an ignition detection device 50, and a door open/close detection device 60.

The communication device 40 is a device configured with a communication device and the like for connecting to a communication network such as the Internet. The communication device 40 may be a wireless LAN-compatible communication device, a long term evolution (LTE)-compatible communication device, or a wire communication device that performs wired communication. The vehicle control device 20 can transmit and receive information to/from a terminal device such as smartphone via the communication device 40.

The ignition detection device 50 is a sensor device connected to the engine switch 10 to detect a state of ignition. The ignition detection device 50 outputs information indicating a state of the ignition switch.

The door open/close detection device 60 is a device that detects the opening and closing of the doors on the driver's seat side and the front passenger's seat side of the front and rear rows of the vehicle 1. For example, the door open/close detection device 60 is, for example, a sensor that detects the opening and closing of the door. The door open/close detection device 60 is arranged, for example, at the hinge of each door. The door open/close detection device 60 detects that the door is at an open angle enough to allow an occupant to get in and out. If it is detected that the door open angle is enough to allow an occupant to get in and out, it can be assumed that a vehicle operation to enable the user of the vehicle 1 to get out of the vehicle has been performed. The user of the vehicle 1 is, for example, an occupant in the rear seat.

The monitoring range setting circuit 201 sets a monitoring range. This monitoring range is a range in which the possibility that the monitoring target becomes lost is taken into consideration and which defines whether to perform a notification process for the monitoring target himself/herself or the occupant in the vehicle 1 (for example, driver), and is a geofence which is a geographical fence. In other words, the vehicle control device 20 does not perform the notification process when the monitoring target belongs in the monitoring range, and performs the notification process when the monitoring target deviates from the monitoring range.

For example, when a mode indicating that a monitoring range is to be set is selected through the user's input operation to the in-vehicle display device 15, the monitoring range setting circuit 201 starts a monitoring range setting process. In the monitoring range setting process, the monitoring range setting circuit 201 accepts input of selection of the exterior imaging circuit 6 to be used in the monitoring process and information defining the monitoring range in the selected exterior imaging circuit 6, through the user's input operation to the in-vehicle display device 15. The information defining the monitoring range in the selected exterior imaging circuit 6 is, for example, distance information from the selected exterior imaging circuit 6.

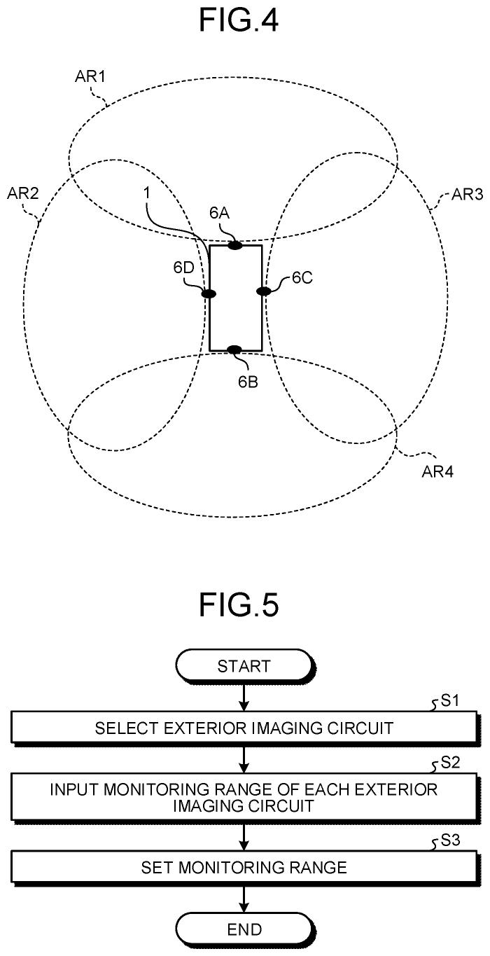

The monitoring range setting circuit 201 sets a monitoring range, based on selection of the exterior imaging circuit 6 to be used in the monitoring process and information defining the monitoring range in the selected exterior imaging circuit 6. An example of the monitoring range will now be described with reference to FIG. 4. FIG. 4 is a diagram illustrating an example of the monitoring range. As illustrated in FIG. 4, when it is input that the exterior imaging circuits 6A to 6D are to be used in the monitoring process, and information indicating monitoring ranges AR1 to AR4 that are the respective monitoring ranges of the exterior imaging circuits 6 is input, the monitoring range setting circuit 201 sets the monitoring ranges AR1 to AR4 as monitoring ranges.

The monitoring range setting circuit 201 may accept only the selection of the exterior imaging circuits 6 to be used in the monitoring process, and the respective image capturing ranges of the exterior imaging circuits 6 may be set as the respective monitoring ranges of the exterior imaging circuits 6. In this way, the monitoring range setting circuit 201 may define the monitoring range, based on the image capturing range of the exterior imaging circuit 6.

The monitoring range setting process will now be described with reference to FIG. 5. FIG. 5 is a flowchart illustrating the monitoring range setting process.

The monitoring range setting circuit 201 accepts selection of the exterior imaging circuits 6 to be used in the monitoring process (step S1). The monitoring range setting circuit 201 then accepts input of information defining the respective monitoring ranges of the exterior imaging circuits 6 (step S2). The monitoring range setting circuit 201 then sets the monitoring range (step S3).

Returning to FIG. 3, the monitoring target setting circuit 202 sets the monitoring target based on the captured image. There are two ways to set the monitoring target: manual monitoring target setting, which is monitoring target setting not induced by learning; and learning-based monitoring target setting. First, the manual monitoring target setting will be described.

When a mode indicating manual registration is selected through the user's input operation to the in-vehicle display device 15, and the exterior imaging circuit 6 or the interior imaging circuit 7 that takes pictures is selected, the monitoring target setting circuit 202 activates the selected exterior imaging circuit 6 or interior imaging circuit 7 and allows the selected imaging circuit to capture an image. The monitoring target setting circuit 202 acquires a captured image from the selected exterior imaging circuit 6 or interior imaging circuit 7, analyzes the captured image, and sets a whole body image and a face image of a person in the captured image as the monitoring target. The monitoring target setting circuit 202 may analyze the captured image transmitted from a terminal device owned by the user and set a whole body image and a face image of a person in the captured image as the monitoring target.

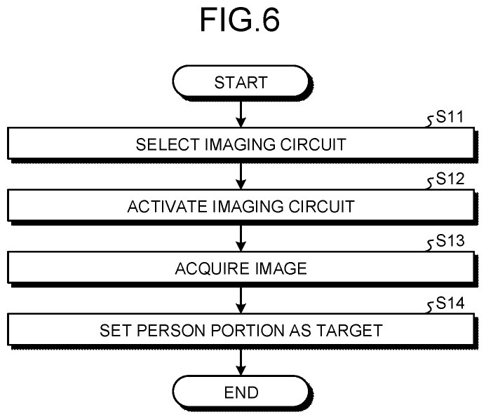

The manual monitoring target setting process will now be described with reference to FIG. 6. FIG. 6 is a flowchart illustrating the manual monitoring target setting process.

The monitoring target setting circuit 202 accepts selection of the exterior imaging circuit 6 or interior imaging circuit 7 to be used for setting the monitoring target (step S11). The monitoring target setting circuit 202 then activates the selected imaging circuit (step S12). The monitoring target setting circuit 202 acquires a captured image from the activated imaging circuit (step S13). The monitoring target setting circuit 202 analyzes the captured image and sets a whole body image and a face image of a person in the captured image as the monitoring target (step S14).

The learning-based monitoring target setting will now be described. At a predetermined timing, such as immediately after the vehicle 1 starts running, the monitoring target setting circuit 202 activates the interior imaging circuit 7 and acquires a captured image, for example, around the rear seat 8 from the interior imaging circuit 7.

The monitoring target setting circuit 202 analyzes the captured image, extracts a whole body image and a face image of a person in the captured image, and stores the date of imaging, the whole body image, and the face image in association with each other as a monitoring target candidate. As a method for extracting a whole body image and a face image of a person in the captured image, the technique described in Japanese Patent Application Laid-open No. 2020-178167 can be applied.

The monitoring target setting circuit 202 refers to the stored monitoring target candidates in the past and determines whether there are more than a threshold number of face images that have the face identical to the face indicated by the face image and were captured on different dates. An example of the threshold is 10. The monitoring target setting circuit 202 can apply the person matching technique described in Japanese Patent Application Laid-open No. 2016-201758 above as a method of referring to the stored monitoring target candidates in the past and determining whether the face in the face image is identical to the face indicated by the face image.

If there are more than the threshold number, the monitoring target setting circuit 202 sets the most recently stored face image and whole body image of the monitoring target candidate as the monitoring target.

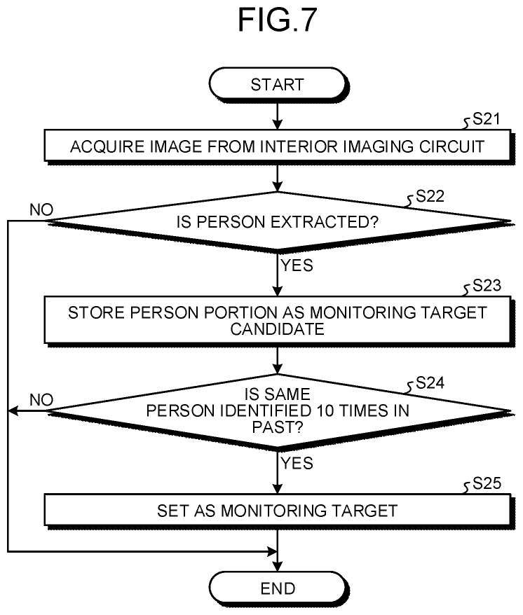

The learning-based monitoring target setting process will now be described with reference to FIG. 7. FIG. 7 is a flowchart illustrating the learning-based monitoring target setting process.

The monitoring target setting circuit 202 acquires a captured image from the interior imaging circuit 7 (step S21). The monitoring target setting circuit 202 then terminates the process if no person is extracted as a result of image analysis of the captured image (No at step S22). On the other hand, if a person is extracted as a result of image analysis of the captured image (Yes at step S22), the monitoring target setting circuit 202 stores the date of imaging, the whole body image, and the face image in association with each other as a monitoring target candidate (step S23).

The monitoring target setting circuit 202 refers to the stored monitoring target candidates in the past and determines whether there are 10 or more face images that have the face identical to the face indicated by the face image and were captured on different dates. If there are not 10 or more face images (No at step S24), the process ends.

If there are 10 or more face images that have the face identical to the face indicated by the face image and were captured on different dates (Yes at step S24), the monitoring target setting circuit 202 sets the most recently stored face image and whole body image of the monitoring target candidate as the monitoring target (step S25).

Returning to FIG. 3, the information acquisition circuit 203 acquires vehicle information. The vehicle information is information indicating a state of the vehicle. Specifically, the vehicle information includes parking brake information, door lock status information, door open/close information, and ignition information.

The parking brake information indicates whether the parking brake 13 of the vehicle is applied or the parking brake 13 is released. The information acquisition circuit 203 receives side brake information from, for example, a sensor device that detects a state of the parking brake 13.

The door lock status information is information indicating whether the door of the vehicle is locked or unlocked. This door lock status information also includes information indicating that the door has been locked by locking from outside the vehicle 1. The information acquisition circuit 203 receives door lock status information from the door lock device 14 that detects the locked state and the unlocked state of the door.

The door open/close information indicates whether the door is open or not. The information acquisition circuit 203 acquires the door open/close information from the door open/close detection device 60.

The ignition information is information indicating a state of the ignition switch. The information acquisition circuit 203 acquires the ignition information from the ignition detection device 50.

The monitoring control circuit 204 executes a monitoring process to determine whether the monitoring target belongs to the monitoring range, based on the captured image by the exterior imaging circuit 6. The monitoring control circuit 204 starts the monitoring process if a monitoring start condition is met, and terminates the monitoring process if a monitoring end condition is met.

The monitoring control circuit 204 sequentially acquires vehicle information from the information acquisition circuit 203 and determines whether the monitoring start condition or the monitoring end condition is met, based on the vehicle information. The monitoring control circuit 204 may activate the exterior imaging circuit 6 and the interior imaging circuit 7 and determine whether the monitoring start condition or the monitoring end condition is met, additionally using the image analysis result of the captured image acquired from the exterior imaging circuit 6 and the interior imaging circuit 7.

The monitoring start condition includes, for example, that the vehicle 1 is not locked from outside, the ignition switch is OFF, the door is open, the parking brake is being applied, and the monitoring target is detected to be outside the vehicle. The monitoring start condition may include that a monitoring start instruction is given by the user's input operation to the in-vehicle display device 15 or the user's terminal.

The monitoring control circuit 204 refers to the door lock status information and determines whether the door is locked by locking from outside the vehicle 1. The monitoring control circuit 204 also refers to the ignition information and determines whether the ignition switch is OFF. The monitoring control circuit 204 also refers to the door open/close information and determines whether the door of the vehicle 1 has been opened. The monitoring control circuit 204 also refers to the parking brake information and determines whether the parking brake is being applied.

The monitoring control circuit 204 analyzes the captured image acquired from the exterior imaging circuit 6 and detects that the monitoring target is outside the vehicle if the captured image includes the face image identical to that of the monitoring target.

The monitoring control circuit 204 starts the monitoring process if the monitoring start condition is met. The monitoring control circuit 204 may start the monitoring process on the condition that the monitoring start condition is met and the monitoring end condition is not met.

The monitoring control circuit 204 activates the exterior imaging circuit 6 that has any one of the monitoring ranges as its imaging range, acquires the captured image from the exterior imaging circuit 6, and searches the acquired captured image for the monitoring target. The monitoring control circuit 204 may search for the monitoring target using not only the face portion of the acquired captured image but also the whole body image. As a technique for searching for the monitoring target using the face portion and the whole body image, the technique described in Japanese Patent Application Laid-open No. 2020-178167 may be applied.

The monitoring control circuit 204 searches for the monitoring target and determines whether the monitoring target belongs to the monitoring range. The monitoring control circuit 204 may determine whether the monitoring target belongs to the monitoring range by specifying the distance from the vehicle 1 to the monitoring target using the captured image including the monitoring target. As a technique for specifying the distance using the captured image, for example, the technique described in Japanese Patent Application Laid-open No. 2007-188417 may be applied, in which the size of the whole body is determined from a pattern of a part of the monitoring target.

As a result of determining whether the monitoring target belongs to the monitoring range based on the distance from the vehicle 1 to the monitoring target, if the monitoring target belongs to the monitoring range, the monitoring control circuit 204 continues to determine again whether the monitoring target belongs to the monitoring range, using the captured image acquired from the exterior imaging circuit 6.

The monitoring control circuit 204 performs a notification process if the monitoring target is not found in any of the captured images acquired from the exterior imaging circuit 6 or if the monitoring target does not belong to the monitoring range.

As the notification process, the monitoring control circuit 204 outputs sound through the exterior speaker 30 to instruct the monitoring target to return in the direction to the vehicle 1. The sound may be pre-recorded voice of the driver, for example. As the notification process, the monitoring control circuit 204 may transmit and output message information to a mobile terminal owned by the monitoring target via the communication device 40 to instruct the monitoring target to return in the direction to the vehicle 1.

As the notification process, the monitoring control circuit 204 may display and output to the in-vehicle display device 15 map information including information indicating the current location and the captured image obtained when the monitoring target belongs to the monitoring range most recently.

If the monitoring target is not found in any of the captured images acquired from the exterior imaging circuit 6 more than once, or if the monitoring target does not belong to the monitoring range for a certain period of time, the monitoring control circuit 204 may display and output to the in-vehicle display device 15 of the vehicle 1 that the monitoring target fails to be identified or deviates from the monitoring range, as the notification process.

The vehicle 1 performs the notification process as described above, whereby the monitoring target is first urged to return voluntarily when the monitoring target no longer belongs to the monitoring range, and if the monitoring target still does not return to the monitoring range, information is output to notify the person riding in the vehicle 1, such as the driver. With this process, the vehicle 1 can prevent the monitoring target located around the vehicle 1, for example, playing around the vehicle 1 far from home, from moving away from the vehicle 1.

The monitoring control circuit 204 terminates the monitoring process if the monitoring end condition is met. The monitoring end condition includes, for example, a condition that the vehicle 1 is locked from outside, the parking brake is turned OFF, or the monitoring target returns to the interior of the vehicle. The monitoring end condition may include that a monitoring end instruction is given by the user's input operation to the in-vehicle display device 15 or the user's terminal.

When the monitoring control circuit 204 terminates the monitoring process if the vehicle 1 is locked from outside or if the parking brake is turned OFF, the monitoring control circuit 204 may display and output information to the in-vehicle display device 15 or the user's terminal device to indicate that the monitoring process is being executed.

The monitoring control circuit 204 refers to the door lock status information and determines whether the door is locked by locking from outside the vehicle 1. The monitoring control circuit 204 refers to the parking brake information and determines whether the parking brake is OFF.

The monitoring control circuit 204 analyzes the captured image acquired from the interior imaging circuit 7 and detects that the monitoring target is back to the interior of the vehicle if the captured image includes the face image identical to that of the monitoring target.

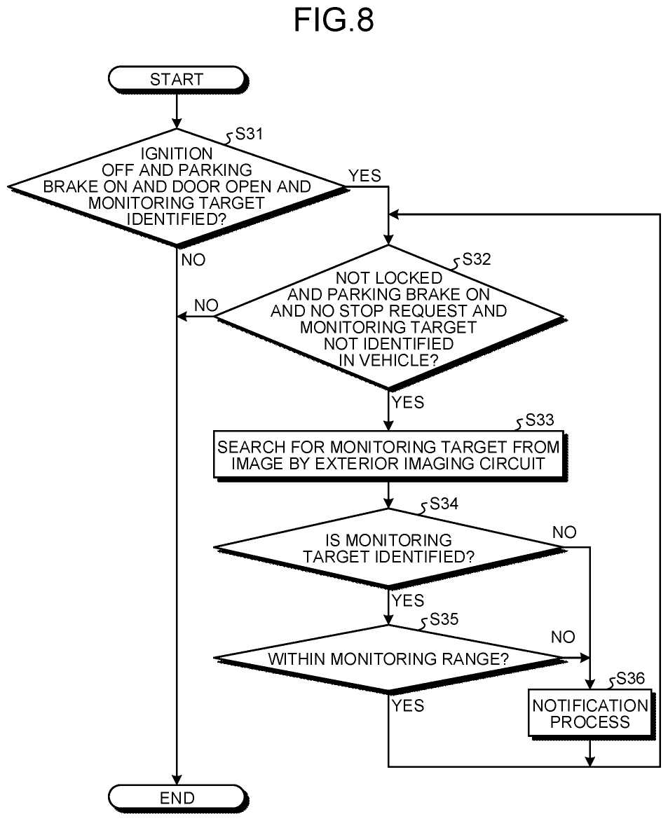

The control procedure of the monitoring process will now be described with reference to FIG. 8. FIG. 8 is a flowchart illustrating the control procedure of the monitoring process.

The monitoring control circuit 204 determines whether the monitoring start condition is met (step S31), and if the monitoring start condition is not met (No at step S31), the process ends. Here, the monitoring start condition is that the ignition is OFF, the parking brake 13 is ON, the door is open, and the monitoring target is found in any of the captured images acquired from the exterior imaging circuit 6 by the exterior imaging circuit 6.

If the monitoring start condition is met (Yes at step S31), the monitoring control circuit 204 proceeds to step S32. At step S32, the monitoring control circuit 204 determines whether the monitoring end condition is not met (step S32). The monitoring end condition is that the vehicle 1 has been locked from outside, or the parking brake is turned OFF, or a request to stop the monitoring process is made from the in-vehicle display device 15 through the user's input operation, or the monitoring target has returned to the interior of the vehicle.

If the monitoring end condition is not met at step S32 (Yes at step S32), the monitoring control circuit 204 performs a process of searching for the monitoring target in the captured image acquired from the exterior imaging circuit 6 (step S33). As a result of the process of searching for the monitoring target, if the monitoring target can be identified (Yes at step S34), and if the monitoring target is within the monitoring range (Yes at step S35), the monitoring control circuit 204 proceeds to step S32 without performing the notification process.

As a result of the process of searching for the monitoring target, if the monitoring target fails to be identified (No at step S34), or if the monitoring target is not within the monitoring range at step S35 (No at step S35), the monitoring control circuit 204 performs the notification process (step S36) and proceeds to step S32. At step S32, if the monitoring end condition is met (No at step S32), the process ends.

In the vehicle control device 20 mounted on the vehicle 1 in the present embodiment, the monitoring target setting circuit 202 sets the monitoring target based on the captured image, and when the monitoring start condition is met, the monitoring control circuit 204 starts the monitoring process to determine whether the monitoring target belongs to the monitoring range based on the captured image by the exterior imaging circuit 6. When the monitoring end condition is met, the monitoring control circuit 204 terminates the monitoring process. The monitoring start condition or the monitoring end condition includes a condition related to vehicle operation, such as the state of the parking brake 13.

In this way, the vehicle 1 controls the monitoring process in conjunction with the operation of the vehicle 1, so that the start or end of the monitoring process can be controlled without requiring a specific operation to start or terminate the monitoring process.

Furthermore, in the vehicle 1, the monitoring start condition includes that the parking brake 13 is being applied. At the timing when the vehicle 1 is parked, the occupant such as a child may move away from the vehicle 1, and the monitoring process is thought to be necessary. Based on this point, the monitoring start condition includes the condition based on the parking state that the parking brake 13 is being applied, whereby the vehicle 1 can properly control the start of the monitoring process.

Furthermore, in the vehicle 1, the monitoring start condition includes that the vehicle is not locked from the outside. When the vehicle is locked from the outside, the driver and other occupants presumably leave the vehicle 1 while the vehicle 1 is parked, so the vehicle 1 does not have to perform the monitoring process. In this way, the vehicle 1 can avoid execution of the monitoring process at a timing when the monitoring process is not necessary.

Furthermore, in the vehicle 1, the monitoring start condition includes that the door of the vehicle 1 is opened. In this way, the monitoring start condition includes that the door is opened, which suggests that the monitoring target leaves the vehicle 1, whereby the vehicle 1 can execute the monitoring process at a more appropriate timing.

Furthermore, in the vehicle 1, the monitoring start condition includes that the monitoring target has been extracted based on the captured image by the exterior imaging circuit 6. In this way, the monitoring start condition includes the condition indicating that the monitoring target stays away from the vehicle 1, whereby the vehicle 1 can execute the monitoring process at a more appropriate timing.

Furthermore, in the vehicle 1, the monitoring end condition includes that the parking brake 13 has been released. In this way, the monitoring end condition includes the condition suggesting that the vehicle 1 is no longer parked and the monitoring process is not necessary, whereby the vehicle 1 can control the monitoring process appropriately.

Furthermore, in the vehicle 1, the monitoring end condition includes that the vehicle 1 has been locked from the outside. When the vehicle is locked from the outside, both the driver and other occupants presumably leave the vehicle 1, so the vehicle 1 can avoid execution of the monitoring process at a timing when the monitoring process is not necessary.

Furthermore, in the vehicle 1, when it is determined that the monitoring target does not belong to the monitoring range based on the captured image by the exterior imaging circuit 6, the notification process is performed. In this way, the vehicle 1 can perform the process of preventing the monitoring target from becoming lost by giving notification when the monitoring target deviates from the monitoring range.

Furthermore, in the vehicle 1, the monitoring target is set based on the captured image by the interior imaging circuit 7 and the past captured images by the interior imaging circuit 7. In this way, since the vehicle 1 sets the monitoring target based on the past captured images, the vehicle 1 can properly set the monitoring target by automatically setting a frequently riding person as the monitoring target, without requiring complicated operations.

Furthermore, in the vehicle 1, the monitoring range is set based on the imaging range of the exterior imaging circuit 6. In this way, the vehicle 1 can properly set the monitoring range without requiring complicated operations.

In the foregoing embodiment, the monitoring start condition is that the vehicle 1 is not locked from the outside, the ignition switch is OFF, the door is open, the parking brake is being applied, and the monitoring target is detected to be outside the vehicle. However, embodiments are not limited to this. For example, additional conditions may be added, or only some of the monitoring start conditions in the foregoing embodiment may be used as the monitoring start condition.

In the foregoing embodiment, the condition includes that the vehicle 1 has been locked from the outside, or that the parking brake is turned OFF, or that the monitoring target has returned to the interior of the vehicle. However, embodiments are not limited to this. Additional conditions may be added, or only some of the monitoring end conditions in the foregoing embodiment may be used as the monitoring end condition.

The result of determining whether the vehicle is parked by detecting the state of the shift lever 12 may be used as the monitoring start condition or the monitoring end condition.

Instead of determining that the vehicle has been locked from the outside, whether there are no occupants may be determined based on the detection result by the human detection sensor 16.

In the foregoing embodiment, it is assumed that the monitoring target is a child. However, the monitoring target may be an elderly person, a pet, or the like. In the foregoing embodiment, the vehicle 1 extracts a monitoring target candidate using the captured image around the rear seat 8 captured by the interior imaging circuit 7. However, the interior imaging circuit 7 may capture an image around the front passenger seat, and the monitoring target candidate may be extracted using the captured image around the front passenger seat.

A computer program executed by the vehicle control device 20 in the present embodiment is provided as a file in an installable or executable format recorded on a computer-readable recording medium such as an optical recording medium such as a digital versatile disk (DVD), a USB memory, or a semiconductor memory such as a solid state disk (SSD).

The computer program executed by the vehicle control device 20 in the present embodiment may be stored on a computer connected to a network such as the Internet and downloaded via the network. The computer program executed by the vehicle control device 20 in the present embodiment may be provided or distributed via a network such as the Internet.

The computer program of the vehicle control device 20 in the present embodiment may be embedded in a ROM or the like in advance.

### Second Embodiment

A vehicle according to a second embodiment has a body with a roof, and a cabin is formed inside the body. The cabin is a space in which occupants such as driver and passengers ride. The main function of the vehicle is to run with occupants riding in the cabin and transport the occupants to a destination. The occupants may request to enhance a sense of speed, a sense of immersion, and realistic sensation in traveling of such a vehicle.

When the vehicle runs forward with occupants in the cabin, the occupants in the cabin can see the view through the front and side windows and feel that the front view is approaching. For example, when the vehicle runs on a road in a tunnel, tunnel illumination approaches from a distance, and as the vehicle runs under the lights, the interior of the cabin successively turns into the color of the lights and then becomes dark again. As the vehicle runs through the sunlight filtering through leaves, bright and dark areas are repeated, and the brightness inside the cabin changes accordingly.

Since the vehicle runs on the ground, the occupants in the cabin drive as if they go through the view on the road ahead, but they cannot see the view above as it is interrupted by the roof. If the view above the occupants is provided in an environment matching the view, it is expected that a sense of speed, a sense of immersion, and realistic sensation can be enhanced for the driving of the vehicle, and the entertainment feature in the cabin can be enhanced.

Then, in the second embodiment, in the vehicle, a plurality of light emitters are disposed in a line along the direction of travel on the ceiling of the cabin, and the respective light emission states of the light emitters are controlled in accordance with an image captured in front of the body, thereby improving the entertainment feature in the cabin.

Specifically, in the vehicle, the body has a roof covering the cabin. The roof has an outer surface and an inner surface. An imaging circuit is disposed at an upper front part in the cabin, and an illumination circuit including a plurality of light emitters disposed in a line along the direction of travel is provided on the inner surface of the roof. The imaging circuit can capture an image in an image acquisition area. The image acquisition area is a region in front of the body and having a height corresponding to the roof. The image acquisition area may be a partial region of the entire region included in the angle of view of the imaging circuit. In the illumination circuit, the respective light emission states of the light emitters change in accordance with an image in the image acquisition area. The imaging circuit acquires an image in the image acquisition area for a plurality of timings. The timings may correspond to a plurality of points aligned at predetermined intervals of the distance that the vehicle should travel. In the illumination circuit, the light emission states of the light emitters temporally change in accordance with temporal change of an attribute of the image in the image acquisition area at a plurality of timings. In the illumination circuit, the light emission states of the light emitters may change so as to flow in a direction opposite to the direction of travel when viewed from inside the cabin. Furthermore, in the illumination circuit, the light emission states of the light emitters spatially change in accordance with temporal change of an attribute of the image in the image acquisition area at a plurality of timings. In the illumination circuit, the light emission states of the light emitters may change in response to an attribute of the image in the image acquisition area. With this configuration, an illumination environment matching the view above can be implemented on the inner surface of the roof, so that a sense of speed, a sense of immersion, and realistic sensation can be enhanced for the driving of the vehicle. The entertainment feature in the cabin therefore can be enhanced.

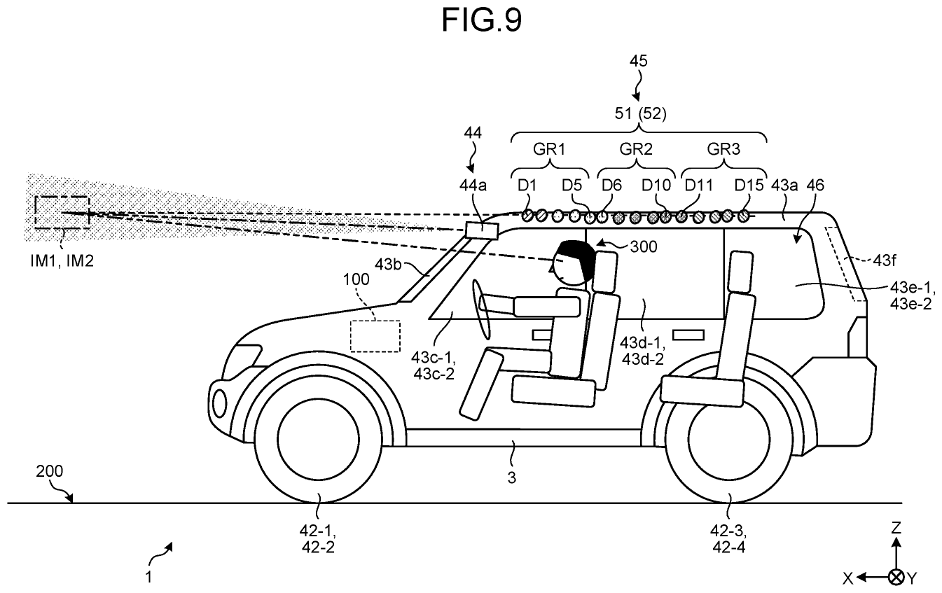

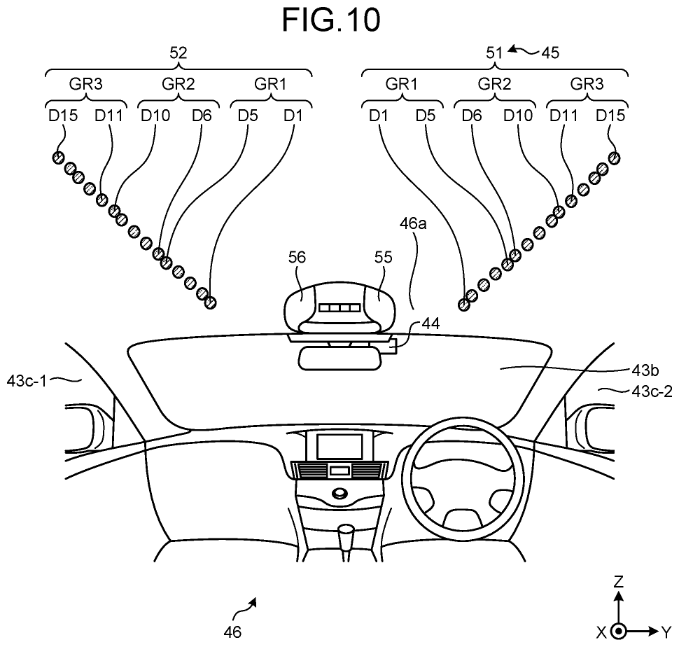

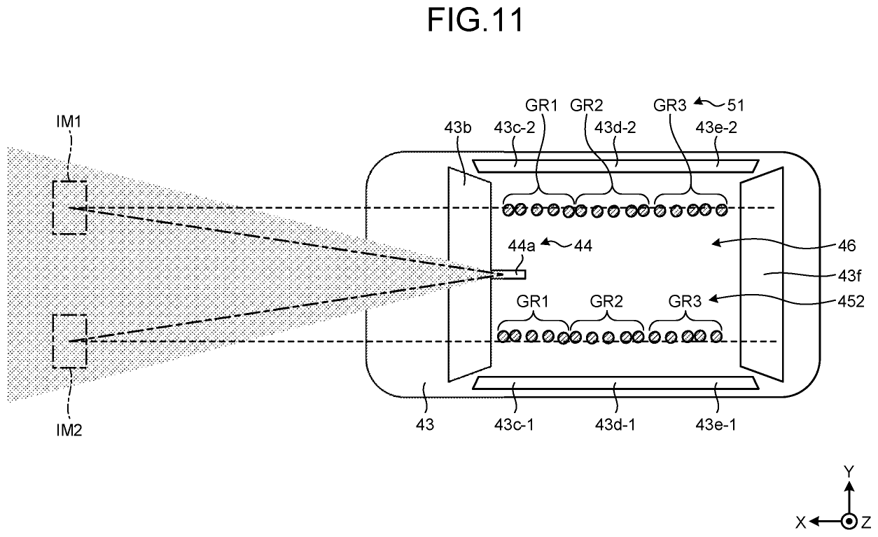

More specifically, the vehicle is configured as illustrated in FIG. 9 to FIG. 11. FIG. 9 is a diagram illustrating an overall configuration of the vehicle according to the second embodiment. FIG. 10 is a diagram illustrating a configuration of the illumination circuit in the second embodiment. FIG. 11 is a diagram illustrating a configuration of the imaging circuit and the illumination circuit in the second embodiment. In the following, the direction of travel of the vehicle 1 is the X direction, the vehicle width direction is the Y direction, and the direction orthogonal to the X and Y directions is the Z direction.

The vehicle 1 includes a plurality of wheels 42-1 to 42-4, a body 43, an imaging circuit 44, an illumination circuit 45, and a vehicle control device 100.

The wheels 42-1 to 42-4 are each rotatable around the Y axis. The wheels (second wheel) 42-3 and 42-4 are disposed on the −X side of the wheels (first wheel) 2-1 and 2-2, and an axle on the +X side and an axle on the −X side (not illustrated) are disposed correspondingly. The wheels 42-1 and 42-2 are respectively joined to the ends on the −Y and +Y sides of the axle on the +X side extending in the Y direction. The wheels 42-3 and 42-4 are respectively joined to the ends on the −Y and +Y sides of the axle on the −X side extending in the Y direction. In FIG. 9, a configuration in which the vehicle 1 has four wheels 42 is illustrated, but the number of wheels 42 may be three or less or five or more.

The body 43 rotatably supports the axles, and the wheels 42-1 to 42-4 are coupled to the body 43 through the axles. The body 43 can move in the X direction by rotation of the wheels 42-1 and 42-2 and the wheels 42-3 and 42-4. The body 43 forms a cabin 46. The body 43 has a roof 43a and a plurality of windows 43b, 43c-1, 43c-2, 43d-1, 43d-2, 43e-1, 43e-2, and 43f. The roof 43a covers the cabin 46 from the +Z side and defines a boundary on the +Z side of the cabin 46. The roof 43a has a surface on the +Z side as an outer surface and a surface on the −Z side as an inner surface. The surface on the −Z side of the roof 43a forms a ceiling 46a of the cabin 46. The windows 43b, 43c-1, 43c-2, 43d-1, 43d-2, 43e-1, 43e-2, and 43f define boundaries on the +X, −Y, +Y, −Y, +Y, −Y, +Y, and −X sides, respectively, of the cabin 46.

The occupant in the cabin 46 can see the view on the +X, −Y, +Y, −Y, +Y, −Y, +Y, and −X sides through the windows 43b, 43c-1, 43c-2, 43d-1, 43d-2, 43e-1, 43e-2, and 43f, but cannot see the view on the +Z side as it is interrupted by the roof 43a. The occupant is, for example, a driver 300 or passenger (not illustrated) in the cabin 46.

The imaging circuit 44 is disposed at the +X and +Z sides in the cabin 46. The imaging circuit 44 may be disposed adjacent to the window 43b on the −X side or may be disposed near an end on the +Z side of the window 43b. The imaging circuit 44 has a camera 44a. The camera 44a has an imaging plane facing the +X side and has an optical axis extending along the X direction as indicated by a dot-dash line in FIG. 9. The optical axis of the camera 44a may be slightly tilted to the +Z side relative to the XY plane passing through the center of the camera 44a.

The imaging circuit 44 can capture an image of the exterior of the body 43 and can capture images in image acquisition areas IM1 and IM2. The imaging circuit 44 may have one camera 44a capable of capturing images in both of the image acquisition areas IM1 and IM2, or may have a plurality of cameras 44a individually capable of capturing images in the image acquisition areas IM1 and IM2. In FIG. 11, a configuration in which the imaging circuit 44 has one camera 44a capable of capturing images in both of the image acquisition areas IM1 and IM2 is illustrated.

The imaging range of the imaging circuit 44 includes a space away from the outer surface of the roof 43a with respect to a ground 200 on which at least one of the wheels 42-1 and 42-2 and wheels 42-3 and 42-4 is grounded. The image acquisition areas IM1 and IM2 are areas in front of the body 43 and having a height corresponding to the roof 43a, and may include, for example, a location where the height from the ground 200 is substantially equal to the height of the ceiling of the cabin 46, as indicated by a dotted line in FIG. 9. The image acquisition areas IM1 and IM2 are areas located higher than the horizontal plane with respect to the position of the eyes of the driver 300. The straight line connecting the position of the eyes of the driver 300 and the center of the image acquisition areas IM1 and IM2 extends along the X direction and may be slightly tilted to the +Z side relative to the XY plane, as indicated by a dash-dot-dot line in FIG. 9. The image acquisition areas IM1 and IM2 may be partial regions of the entire region included in the angle of view of the camera 44a.

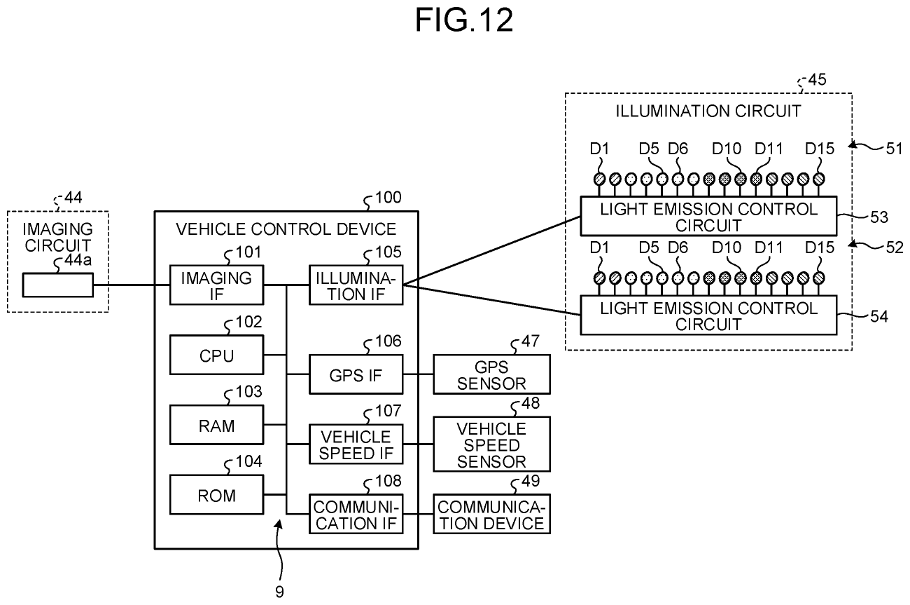

The illumination circuit 45 is disposed on the +Z side in the cabin 46. The illumination circuit 45 illuminates the inside of the cabin 46. The illumination circuit 45 includes a light emitter group 51, a light emitter group 52, a light emission control circuit 53, a light emission control circuit 54 (see FIG. 12), a light source 55, and a light source 56.

The light emitter group 51 is disposed on the +Z side in the cabin 46 in a region extending from the +X side to the −X side. The light emitter group 51 includes a plurality of light emitters GR1 to GR3. In FIG. 9 to FIG. 11, a configuration in which the light emitter group 51 includes three light emitters GR1 to GR3 is illustrated, but the number of light emitters of the light emitter group 51 may be two or may be four or more. The light emitters GR1 to GR3 of the light emitter group 51 are disposed in a line along the X direction on the ceiling in the cabin 46. The arrangement of the light emitters GR1 to GR3 of the light emitter group 51 is not necessarily straight and may be gently curved to conform to the shape of the roof 43a of the body 43.

Each of the light emitters GR1 to GR3 of the light emitter group 51 may have a plurality of light sources disposed in a line along the X direction. The light emitter GR1 includes a plurality of light sources D1 to D5 disposed in a line along the X direction. The light emitter GR2 includes a plurality of light sources D6 to D10 disposed in a line along the X direction. The light emitter GR3 includes a plurality of light sources D11 to D15 disposed in a line along the X direction.

The light emitters GR1 to GR3 of the light emitter group 51 may be disposed slightly on the +Y side with respect to the center in the Y direction in the ceiling in the cabin 46. Each of the light sources D1 to D15 of the light emitter group 51 is, for example, a light emission diode (LED). Each of the light sources D1 to D15 of the light emitter group 51 can adjust its brightness by performing at least one of: changing the duty ratio of voltage; and changing the magnitude of fed current. The emission color of each of the light sources D1 to D15 of the light emitter group 51 may be colored or monochrome, such as R (red), G (green), B (blue), or white. In the following, a case where the emission color of each of the light sources D1 to D15 of the light emitter group 51 is colored will be mainly described by way of example. Each of the light emitters GR1 to GR3 of the light emitter group 51 may be an LED display, a liquid crystal display, or an organic EL display extending along the X direction, instead of a plurality of light sources disposed in a line along the X direction.

The image acquisition area IM1 corresponds to a plurality of light emitters GR1 to GR3 of the light emitter group 51. The straight line along the direction in which the light emitters GR1 to GR3 of the light emitter group 51 are disposed passes through the image acquisition area IM1, as indicated by a dotted line in FIG. 9 to FIG. 11. The straight line along the direction in which the light emitters GR1 to GR3 of the light emitter group 51 are disposed may further pass through the vicinity of the vanishing point in the angle of view of the imaging circuit 44. The illumination circuit 45 can change the respective light emission states of the light emitters GR1 to GR3 of the light emitter group 51 in accordance with an image in the image acquisition area IM1 captured by the imaging circuit 44.

For example, the imaging circuit 44 acquires an image in the image acquisition area IM1 for a plurality of timings. The timings may correspond to a plurality of points aligned at predetermined intervals of the distance that the vehicle 1 should travel.

The light emission control circuit 53 changes the light emission state of each light emitter GR1 to GR3 of the light emitter group 51 in response to the movement along the direction of travel of the body 43 and an image captured by the imaging circuit 44, under control of the vehicle control device 100. The light emission control circuit 53 changes the light emission state of each light emitter GR1 to GR3 of the light emitter group 51 in response to the movement along the direction of travel of the body 43 and an image captured by the imaging circuit 44 a predetermined period of time before. The predetermined period of time may vary depending on the speed of movement of the vehicle 1 in a predetermined direction.

The light emission control circuit 53 temporally changes the light emission states of the light emitters GR1 to GR3 of the light emitter group 51 in accordance with temporal change of an attribute of the image in the image acquisition area IM1. The light emission control circuit 53 changes the light emission states of the light emitters GR1 to GR3 of the light emitter group 51 so as to flow in a direction opposite to the direction of travel when viewed from inside of the cabin 46, in accordance with temporal change of an attribute of the image in the image acquisition area IM1. The light emission control circuit 53 may change the light and dark pattern of the light emitters GR1 to GR3 of the light emitter group 51 so as to flow in a direction opposite to the direction of travel when viewed from inside of the cabin 46, in accordance with temporal change of an attribute of the image in the image acquisition area IM1. The light emission control circuit 53 may change the color pattern of the light emitters GR1 to GR3 of the light emitter group 51 so as to flow in a direction opposite to the direction of travel, in accordance with temporal change of an attribute of the image in the image acquisition area IM1.

Furthermore, the light emission control circuit 53 spatially changes the light emission states of the light emitters GR1 to GR3 of the light emitter group 51 in accordance with temporal change of an attribute of the image in the image acquisition area IM1, under control of the vehicle control device 100. The light emission control circuit 53 changes the light emission states of the light emitters GR1 to GR3 of the light emitter group 51 in response to an attribute of the image in the image acquisition area IM1. The light emission control circuit 53 may change the light and dark pattern of the light emitters GR1 to GR3 of the light emitter group 51 in response to the pattern of luminance of the image in the image acquisition area IM1. The light emission control circuit 53 may change the color pattern of the light emitters GR1 to GR3 of the light emitter group 51 in response to the pattern of color component values of the image in the image acquisition area IM1.

The light emitter group 52 is disposed on the +Z side in the cabin 46 in a region extending from the +X side to the −X side. The light emitter group 52 includes a plurality of light emitters GR1 to GR3. In FIG. 9 to FIG. 11, a configuration in which the light emitter group 52 has three light sources D1 to D15 is illustrated, but the number of light sources of the light emitter group 52 may be two or four or more. The light emitters GR1 to GR3 of the light emitter group 52 are aligned with the light emitters GR1 to GR3 of the light emitter group 51 in the Y direction. The light emitters GR1 to GR3 of the light emitter group 52 are disposed in a line along the X direction on the ceiling in the cabin 46. The arrangement of the light emitters GR1 to GR3 of the light emitter group 52 is not necessarily straight and may be gently curved to conform to the shape of the roof 43a of the body 43.

Each of the light emitters GR1 to GR3 of the light emitter group 52 may have a plurality of light sources disposed in a line along the X direction. The light emitter GR1 includes a plurality of light sources D1 to D5 disposed in a line along the X direction. The light emitter GR2 includes a plurality of light sources D6 to D10 disposed in a line along the X direction. The light emitter GR3 includes a plurality of light sources D11 to D15 disposed in a line along the X direction.

The light emitters GR1 to GR3 of the light emitter group 52 may be disposed slightly on the −Y side with respect to the center in the Y direction in the ceiling in the cabin 46. Each of the light sources D1 to D15 of the light emitter group 52 is, for example, a light emission diode (LED). Each of the light sources D1 to D15 of the light emitter group 52 can adjust its brightness by performing at least one of: changing the duty ratio of voltage; and changing the magnitude of fed current. The emission color of each of the light sources D1 to D15 of the light emitter group 52 may be colored or monochrome, such as R (red), G (green), B (blue), or white. In the following, a case where the emission color of each of the light sources D1 to D15 of the light emitter group 52 is colored will be mainly described by way of example. Each of the light emitters GR1 to GR3 of the light emitter group 52 may be an LED display, a liquid crystal display, or an organic EL display extending along the X direction, instead of a plurality of light sources disposed in a line along the X direction.

The image acquisition area IM2 corresponds to a plurality of light emitters GR1 to GR3 of the light emitter group 52. The straight line along the direction in which the light emitters GR1 to GR3 of the light emitter group 52 are disposed passes through the image acquisition area IM2, as indicated by a dotted line in FIG. 9 to FIG. 11. The straight line along the direction in which the light emitters GR1 to GR3 of the light emitter group 52 are disposed may further pass through the vicinity of the vanishing point in the angle of view of the imaging circuit 44. The illumination circuit 45 can change the respective light emission states of the light emitters GR1 to GR3 of the light emitter group 52 in accordance with an image in the image acquisition area IM2 captured by the imaging circuit 44.

For example, the imaging circuit 44 acquires an image in the image acquisition area IM2 for a plurality of timings. The timings may correspond to a plurality of points aligned at predetermined intervals of the distance that the vehicle 1 should travel.

The light emission control circuit 54 changes the light emission state of each light emitter GR1 to GR3 of the light emitter group 51 in response to the movement along the direction of travel of the body 43 and an image captured by the imaging circuit 44, under control of the vehicle control device 100. The light emission control circuit 53 changes the light emission state of each light emitter GR1 to GR3 of the light emitter group 51 in response to the movement along the direction of travel of the body 43 and an image captured by the imaging circuit 44 a predetermined period of time before. The predetermined period of time may vary depending on the speed of movement of the vehicle 1 in a predetermined direction.

The light emission control circuit 54 temporally changes the light emission states of the light emitters GR1 to GR3 of the light emitter group 52 in accordance with temporal change of an attribute of the image in the image acquisition area IM2. The light emission control circuit 54 changes the light emission states of the light emitters GR1 to GR3 of the light emitter group 52 so as to flow in a direction opposite to the direction of travel when viewed from inside of the cabin 46, in accordance with temporal change of an attribute of the image in the image acquisition area IM2. The light emission control circuit 54 may change the light and dark pattern of the light emitters GR1 to GR3 of the light emitter group 52 so as to flow in a direction opposite to the direction of travel when viewed from inside of the cabin 46, in accordance with temporal change of an attribute of the image in the image acquisition area IM2. The light emission control circuit 54 may change the color pattern of the light emitters GR1 to GR3 of the light emitter group 52 so as to flow in a direction opposite to the direction of travel when viewed from inside of the cabin 46, in accordance with temporal change of an attribute of the image in the image acquisition area IM2.

Furthermore, the light emission control circuit 54 spatially changes the light emission states of the light emitters GR1 to GR3 of the light emitter group 52 in accordance with temporal change of an attribute of the image in the image acquisition area IM2, under control of the vehicle control device 100. The light emission control circuit 54 changes the light emission states of the light emitters GR1 to GR3 in accordance with an attribute of the image in the image acquisition area IM2. The light emission control circuit 54 may change the light and dark pattern of the light emitters GR1 to GR3 of the light emitter group 52 in response to the pattern of luminance of the image in the image acquisition area IM2. The light emission control circuit 54 may change the color pattern of the light emitters GR1 to GR3 of the light emitter group 52 in response to the pattern of color component values of the image in the image acquisition area IM2.

As illustrated in FIG. 10, the light sources 55 and 56 are disposed on the +Z side and the +X side in the cabin 46. The light sources 55 and 56 can illuminate near the seat of the driver 300 and near the front passenger seat, respectively.

The vehicle control device 100 is an information processing device that can be mounted on the vehicle 1 and is disposed at any position in the body 43, for example, at the position indicated by the dotted line in FIG. 9. The vehicle control device 100 may be, for example, an electronic control unit (ECU), an on board unit (OBU), or an external device installed near the dashboard of the vehicle 1.

The vehicle control device 100 can be configured in terms of hardware as illustrated in FIG. 12. FIG. 12 is a diagram illustrating a hardware configuration of the vehicle control device 100.

The vehicle control device 100 includes an imaging interface (IF) 101, a central processing unit (CPU) 102, a random access memory (RAM) 103, a read only memory (ROM) 104, an illumination IF 105, a global positioning system (GPS) IF 106, a vehicle speed IF 107, a communication IF 108, and a bus 109. The imaging IF 101, the CPU 102, the RAM 103, the ROM 104, the illumination IF 105, the GPS IF 106, the vehicle speed IF 107, and the communication IF 108 are connected to communicate with each other via the bus 109. A control program is stored in the ROM 104.

The imaging IF 101 is connected to communicate with the imaging circuit 44 via a cable or the like. The imaging IF 101 acquires an image captured by the imaging circuit 44. The imaging IF 101 continuously acquires a plurality of frame images of moving images captured by the imaging circuit 44.

The illumination IF 105 is connected to communicate with each of the light emission control circuits 53 and 54 in the illumination circuit 45 via a CAN, a cable, or the like. The illumination IF 105 can supply a control signal to each of the light control circuits 53 and 54. Thus, the illumination IF 105 can control a lighting state of each of the light sources D1 to D15 of the light emitter groups 51 and 52.

The GPS IF 106 is connected to communicate with a GPS sensor 47 via a CAN, a cable, or the like. The GPS sensor 47 receives GPS signals. The GPS IF 106 acquires GPS signals received by the GPS sensor 47 and generates location information such as latitude, longitude, and altitude of the vehicle 1 based on the GPS signals.

The vehicle speed IF 107 is connected to communicate with a vehicle speed sensor 48 via a CAN, a cable, or the like. The vehicle speed sensor 48 is disposed near the wheel 42 and generates a vehicle speed pulse indicating the rotational speed or the number of revolutions of the wheel 42. The vehicle speed IF 107 acquires a vehicle speed pulse generated by the vehicle speed sensor 48 and determines the traveling speed of the vehicle 1 based on the vehicle speed pulse.

The communication IF 108 is connected to communicate with a communication device 9 via a CAN, a cable, or the like. The communication device 9 can communicate with a server device (not illustrated) mainly via a wireless communication circuit and receive predetermined information from the server device. The communication IF 108 can acquire the predetermined information from the server device via the communication device 9.

The GPS sensor 47 and the vehicle speed sensor 48 are used to detect the location and the amount of movement of the vehicle and can function as a movement detector set to detect movement of the body 43 in a predetermined direction of travel. The movement detector may be substituted by another means that can detect movement of the body 43 in a predetermined direction of travel and has similar effects.

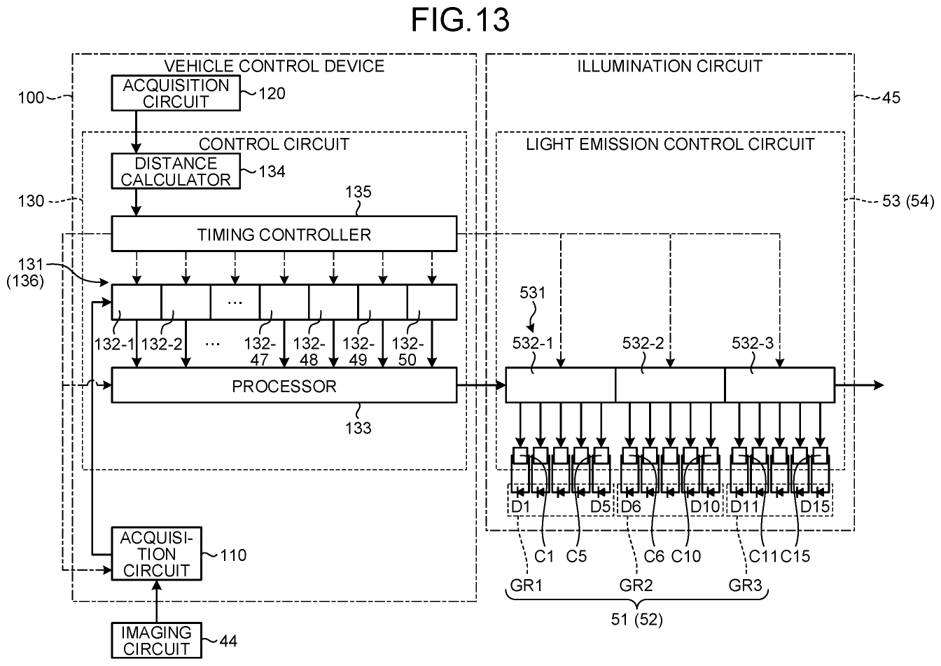

The vehicle control device 100 can be configured as illustrated in FIG. 13 in terms of functions. FIG. 13 is a diagram illustrating a functional configuration of the vehicle control device 100. The CPU 102 reads a control program from the ROM 104 and loads the functional configuration illustrated in FIG. 13 in a buffer area of the RAM 103, collectively during compiling of the control program or sequentially with the progress of processing by the control program.

The vehicle control device 100 includes an acquisition circuit 110, an acquisition circuit 120, and a control circuit 130. The control circuit 130 includes a plurality of shift registers 131 and 136, a processor 133, a distance calculator 134, and a timing controller 135. Each of the shift registers 131 and 136 includes registers 132-1 to 132-50 on multiple stages.

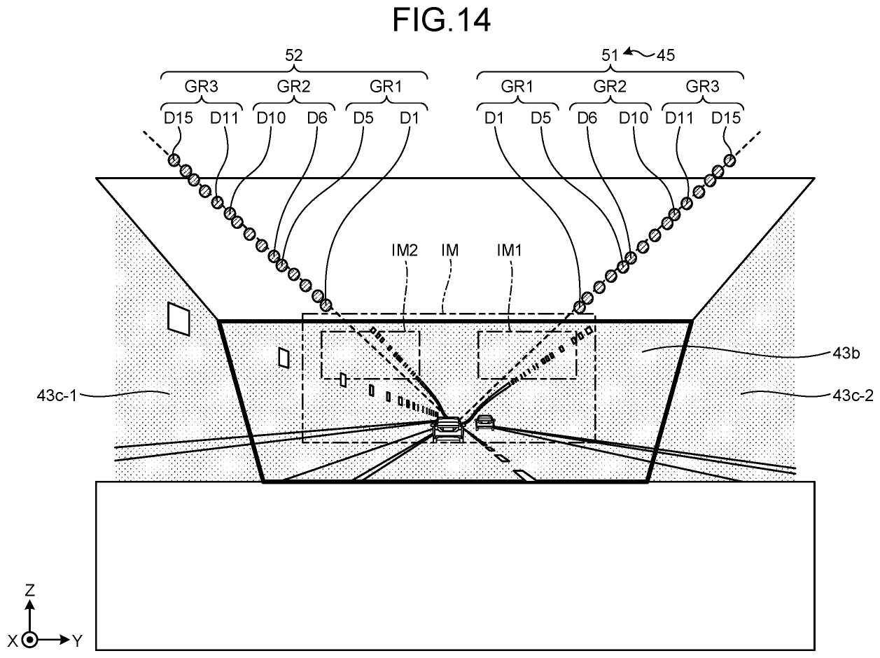

The acquisition circuit 110 acquires images in the image acquisition areas IM1 and IM2. The acquisition circuit 110 acquires, for example, a whole image IM as illustrated in FIG. 14 that is captured by the imaging circuit 44. FIG. 14 is a diagram illustrating the positions IM1 and IM2 of image acquisition areas in the whole image IM. FIG. 14 illustrates the whole image IM and the positions IM1 and IM2 of the image acquisition areas relative to the front view seen through the window 43b from inside the cabin 46 corresponding to FIG. 10. The acquisition circuit 110 clips the image acquisition areas IM1 and IM2 from the acquired whole image IM. The positions of the image acquisition areas IM1 and IM2 to be clipped in the whole image IM are predetermined and set in the control program.

As indicated by a dotted line in FIG. 14, the position of the image acquisition area IM1 in the whole image IM is a position corresponding to the arrangement direction of the light emitters GR1 to GR3 of the light emitter group 51 disposed on the ceiling in the cabin 46, for example, the position on the +Y and +Z sides with respect to the center of the whole image IM. As indicated by a dotted line in FIG. 14, the position of the image acquisition area IM2 in the whole image IM is a position corresponding to the arrangement direction of the light emitters GR1 to GR3 of the light emitter group 52 disposed on the ceiling in the cabin 46, for example, the position on the −Y and +Z sides with respect to the center of the whole image IM.

The acquisition circuit 120 illustrated in FIG. 13 acquires the traveling speed of the vehicle 1 obtained by the vehicle speed IF 107. The acquisition circuit 120 supplies the traveling speed of the vehicle 1 to the distance calculator 134 of the control circuit 130.

The distance calculator 134 calculates the distance traveled by the vehicle 1, for example, by integrating the traveling speed. The distance calculator 134 supplies the distance traveled by the vehicle 1 to the timing controller 135.

A plurality of shift registers 131 and 136 correspond to a plurality of image acquisition areas IM1 and IM2, correspond to a plurality of light emission control circuits 53 and 54, and correspond to a plurality of light emitter groups 51 and 52. The shift register 131 includes registers 132-1 to 132-50 on multiple stages. Each of the shift registers 131 and 136 receives and holds an image in the corresponding image acquisition area IM1, IM2, and shifts the image held in the register 132 to the register 132 on the next stage at a timing controlled by the timing controller 135. In the following, the shift register 131, the image acquisition area IM1, the light emission control circuit 53, and the light emitter group 51 will be mainly described by way of example, but this is applicable to the shift register 136, the image acquisition area IM2, the light emission control circuit 54, and the light emitter group 52.

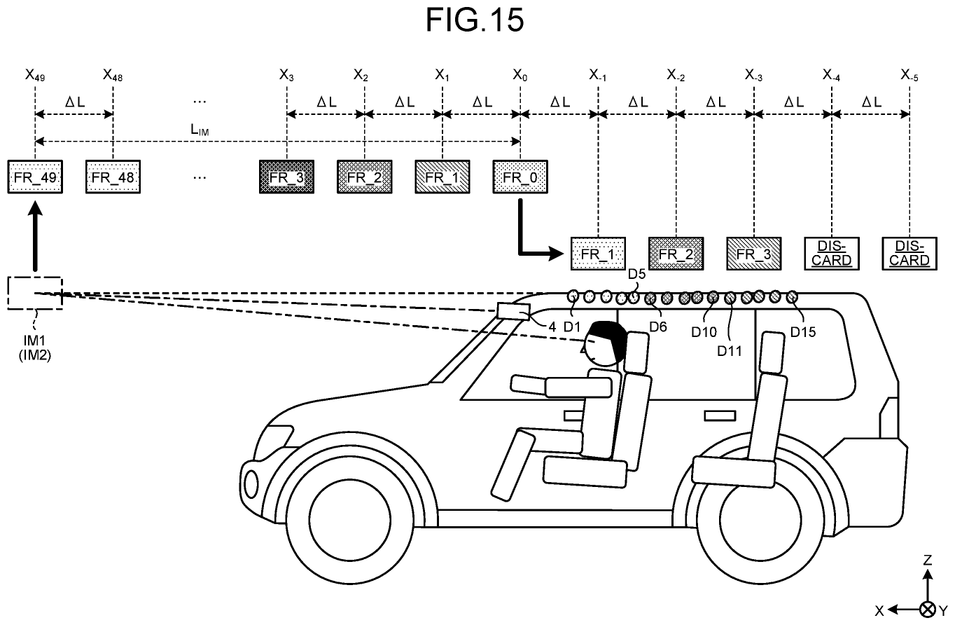

The timing controller 135 successively determines a plurality of timings with reference to the point of the image acquisition area IM1, in accordance with the distance traveled by the vehicle 1. As illustrated in FIG. 15, the timings correspond to a plurality of points obtained by dividing a distance LIM from the position of the imaging circuit 44 of the vehicle 1 to the point of the image acquisition area IM1 by a predetermined interval ΔL. Each timing is the timing when the vehicle 1 passes through the corresponding point. FIG. 15 is a diagram illustrating spatial changes of the light emitters GR1 to GR3 in accordance with images at a plurality of timings. FIG. 15 illustrates a case where the distance LIM to the image acquisition area IM1 is equal to ΔL×49.

If the road is undulating or winding, the acquired image may differ from the actual location that the vehicle passes through. Therefore, the distance LIM may be set to, for example, such a distance that the time from acquisition of the image acquisition area IM1 to passage through the point of the image acquisition area IM1 is two to three seconds. The distance LIM may be, for example, several tens of meters. The predetermined interval ΔL and the number of dividing can be determined as desired in accordance with the traveling speed of the vehicle 1, the specifications of the imaging circuit 44, and the like.

A plurality of timings to be determined by the timing controller 135 correspond to a plurality of points aligned at predetermined intervals of the distance that the vehicle 1 should travel.

In FIG. 15, the X position of the image acquisition area IM1 is x₄₉ and the X position of the imaging circuit 44 of the vehicle 1 is x₀. When the position of the vehicle 1 is represented by the X position of the imaging circuit 44, the vehicle 1 travels in the X direction and successively passes through a plurality of points x₀, x₁, x₂, . . . , x₄₉. The points x₀, x₁, x₂, . . . , x₄₉ correspond to a plurality of points aligned in the X direction at predetermined intervals ΔL from each other. Let t₀, t₁, t₂, . . . , t₄₉ be the timings when the vehicle 1 passes through the points x₀, x₁, x₂, . . . , x₄₉.

Each of the timings is a timing when an image acquired by the acquisition circuit 110 illustrated in FIG. 13 should be stored in the shift register 131. The timing controller 135 supplies the determined timing to the acquisition circuit 110. The acquisition circuit 110 continuously acquires a plurality of frame images in moving images captured by the imaging circuit 44, and selects a frame image acquired from the imaging circuit 44 and stores the selected frame image into the register 132 on the first stage of the shift register 131 at a timing controlled by the timing controller 135.

In FIG. 15, at timing to, the acquisition circuit 110 selects a frame image as the whole image IM, clips an image FR_49 of the image acquisition area IM1 from the frame image, and stores the image FR_49 into the register 132 on the first stage of the shift register 131.

Each of the timings is a timing when the shift register 131 illustrated in FIG. 13 shifts the image stored in the register 132 on each stage. The timing controller 135 supplies the determined timing to the register 132 on each stage of the shift register 131. The register 132-1 to 132-49 on each stage transfers an image to the register 132 on the next stage and the processor 133 at a timing controlled by the timing controller 135. The register 132-50 on the final stage supplies an image to the processor 133 at a timing controlled by the timing controller 135.

In FIG. 15, at timing to, shift register 131 transfers an image FR_48 to FR_0 of the image acquisition area IM1 stored in the register 132-1 to 132-49 on each stage to the register 132 on the next stage. In FIG. 15, a transferred state is illustrated.

Each of the timings is a timing for performing image processing in the processor 133 illustrated in FIG. 13. The processor 133 acquires an image from the register 132-1 to 132-50 on each stage of the shift register 131 at a timing controlled by the timing controller 135, and performs statistical processing on the acquired images.

Each of the light emission control circuits 53 and 54 of the illumination circuit 45 has a shift register 531 and a plurality of control circuits C1 to C15. The control circuits C1 to C15 correspond to a plurality of light sources D1 to D15. The shift register 531 includes registers 532-1 to 532-3 on multiple stages. The register 532-1 corresponds to the control circuits C1 to C5, the register 532-2 corresponds to the control circuits C6 to C10, and the register 532-3 corresponds to the control circuits C11 to C15. Each of the control circuits C1 to C15 is connected to the corresponding light source and turns the light source on or off or changes the brightness or color of the light source.

The processor 133 generates a control value for controlling the light source based on the image acquired from the register 132-50 on the final stage, considering the result of statistical processing. The processor 133 stores the control value into the register 532 on the first stage of the shift register 531. The control value may include a Y value indicating luminance, an R value that is a red color component value, a G value that is a green color component value, and a B value that is a blue color component value.

The control of vehicle interior illumination may be performed for one light source at a time, may be performed for a plurality of light sources in a batch, or may be performed all in a batch. When the control is performed for a plurality of light sources in a batch or for all in a batch, the old luminance, the lighting color and luminance, and color are smoothed and complemented so that they change smoothly. If the number of image frames is less than the number of units of control for vehicle interior illumination, the luminance and the lighting color may be complemented to change smoothly from the previous and subsequent images.

In FIG. 13, the control for a plurality of light sources in a batch is illustrated. In this case, the light emitter group 51 may be grouped into a plurality of light emitters GR1 to GR3. The light emitter GR1 includes light sources D1 to D5, the light emitter GR2 includes light sources D6 to D10, and the light emitter GR3 includes light sources D11 to D15. The light emitter GR1 corresponds to the register 532-1 and corresponds to the control circuits C1 to C5. The light emitter GR2 corresponds to the register 532-2 and corresponds to the control circuits C6 to C10. The light emitter GR3 corresponds to the register 532-3 and corresponds to the control circuits C11 to C15.

The control value stored in the register 532-1 on the first stage of the shift register 531 is supplied to the control circuits C1 to C5 corresponding to the light emitter GR1. The control circuits C1 to C5 control the brightness and color of the light sources D1 to D5 in accordance with the control value.

In FIG. 15, at timing to, the processor 133 performs statistical processing on a plurality of images FR_49 to FR_0, generates a control value FR_−1 in accordance with the result of the statistical processing, and stores the control value FR_−1 into the register 532 on the first stage of the shift register 531. In FIG. 15, luminance is indicated by the density of hatching, and hatching with a lower density indicates brighter luminance. The control value FR_−1 indicates relatively bright luminance. In response, the control circuits C1 to C5 turn on the light sources D1 to D5 of the light emitter GR1 in a color in accordance with the control value FR_−1 and at relatively high brightness in accordance with the control value FR_−1.

Each of the timings is a timing for changing the control of the light emitter group 51 by the light emission control circuit 53 illustrated in FIG. 13, and a timing for the shift register 531 to shift the control value stored in the register on each stage. The timing controller 135 supplies the determined timing to the register 532 on each stage of the shift register 531. The register 532-1 to 532-3 on each stage transfers the control value to the register 532 on the next stage at a timing controlled by the timing controller 135. The register 532-3 on the final stage discards the control value at a timing controlled by the timing controller 135.

In FIG. 15, at timing to, the shift register 531 transfers the control value FR_−2, FR_−3 stored in the register 532-1, 532-2 on each stage to the register 132 on the next stage and discards the control value FR_−4 stored in the register 532-3 on the final stage. In FIG. 15, a transferred state is illustrated. In response, the control circuits C6 to C10 turn on the light sources D6 to D10 of the light emitter GR2 in a color in accordance with the control value FR_−2 and at relatively dark brightness in accordance with the control value FR_−2. The control circuits C11 to C15 turn on the light sources D11 to D15 of the light emitter GR3 in a color in accordance with the control value FR_−3 and at intermediate brightness in accordance with the control value FR_−3.

As illustrated in FIG. 15, when a plurality of light sources correspond to a plurality of points, the lighting state of the light source corresponding to each point is controlled to match the attribute of an image acquired at that point. As for timing to, the lighting state of the light sources D1 to D5 of the light emitter GR1 corresponding to point x₋₁ is controlled to match the attribute of the image FR_1 in the image acquisition area IM1 acquired at point x₋₁, the lighting state of the light sources D6 to D10 of the light emitter GR2 corresponding to point x₋₂ is controlled to match the attribute of the image FR_−2 in the image acquisition area IM1 acquired at point x₋₂, and the lighting state of the light sources D11 to D15 of the light emitter GR3 corresponding to point x₋₃ is controlled to match the attribute of the image FR_−3 in the image acquisition area IM1 acquired at point x₋₃.

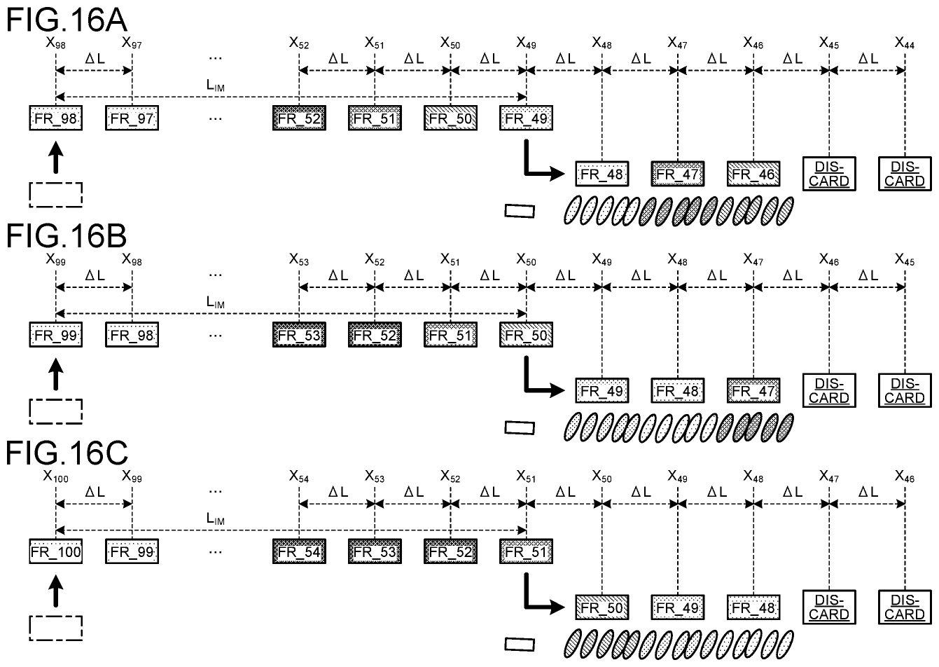

For example, as illustrated in FIG. 16A, the image FR_49 in the image acquisition area IM1 acquired at timing point x₄₉ illustrated in FIG. 15 at timing to is stored into the register 132-50 on the final stage of the shift register 131 illustrated in FIG. 13 at timing t₄₉ when the vehicle 1 reaches point x₄₉. FIGS. 16A to 16C are diagrams illustrating temporal changes of the light emitters GR1 to GR3 in accordance with images at a plurality of timings. In this case, the processor 133 acquires an image from the register 132-1 to 132-50 on each stage and performs statistical processing on the acquired images.

As illustrated in FIG. 16B, at timing t₅₀ when the vehicle 1 reaches point x₅₀, the processor 133 generates a control value FR_49 for controlling the light sources based on the image acquired from the register 132-50 on the final stage, considering the result of statistical processing. The processor 133 stores the control value FR_49 into the register 532-1 on the first stage of the shift register 531. In response, the control circuits C1 to C5 turn on the light sources D1 to D5 of the light emitter GR1 corresponding to point x₄₉ in a color in accordance with the control value FR_49 and at intermediate brightness in accordance with the control value FR_49.

As illustrated in FIG. 16C, at timing t₅₁ when the vehicle 1 reaches an X position x₅₁, the register 532-1 on the first stage of the shift register 531 transfers the control value FR_49 to the register 532-2 on the next stage. In response, the control circuits C6 to C10 turn on the light sources D6 to D10 of the light emitter GR2 corresponding to point x₄₉ in a color in accordance with the control value FR_49 and at intermediate brightness in accordance with the control value FR_49.

Although not illustrated in the drawing, at timing t₅₂ when the vehicle 1 reaches an X position x₅₂, the register 532-2 of the shift register 531 transfers the control value FR_49 to the register 532-3 on the next stage. In response, the control circuits C11 to C15 turn on the light sources D11 to D15 of the light emitter GR3 corresponding to the point x₄₉ in a color in accordance with the control value FR_49 and at intermediate brightness in accordance with the control value FR_49.

As illustrated in FIG. 15 and FIGS. 16A to 16C, the attribute of an image captured for a certain point is converted into a control value for the light sources when the vehicle reaches the certain point, and the light source that reflects the control value is successively switched as the light source corresponding to the certain point among a plurality of light sources successively changes in a direction opposite to the direction of travel. As for the image FR_98, the image is captured at timing to illustrated in FIG. 15, its attribute is converted into the control value FR_49 at timing t₄₉ illustrated in FIG. 16A, the control value FR_49 is reflected in light emission control of the light sources D1 to D5 of the light emitter GR1 at timing t₅₀ illustrated in FIG. 16B, the control value FR_49 is reflected in light emission control of the light sources D6 to D10 of the light emitter GR2 at timing t₅₁ illustrated in FIG. 16C, and the control value FR_49 is reflected in light emission control of the light sources D11 to D15 of the light emitter GR3 at timing t₅₂ not illustrated in the drawing. Thus, the light emission states of the light emitters GR1 to GR3 are controlled so as to flow in a direction opposite to the direction of travel when viewed from inside the cabin 46.

As the statistical processing performed in the processor 133 illustrated in FIG. 13, any statistical processing can be used that ensures that the vehicle interior illumination matches the occupant's experience when the attribute of the captured image is reflected in the vehicle interior illumination.

It is possible to use image capturing of only one pixel of the camera per image acquisition area in the control of line illumination. In this case, one pixel is acquired from one point on the extension of the dotted line in FIG. 14. In the example in FIG. 14, the line illumination is dark because tunnel illumination is not reflected on the extension of the dotted line and therefore one pixel is almost dark. As the vehicle 1 moves, the vehicle 1 passes through the tunnel illumination. In other words, it is necessary to reflect the tunnel illumination in order to match with the experience.

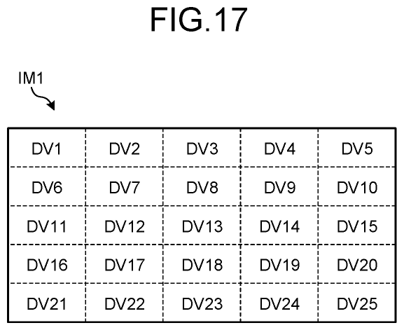

In order to match with the experience, the image acquisition area is set in a horizontally long ellipse or a horizontally long rectangle centered on one point on the dotted line in FIG. 14. FIG. 14 illustrates a case where a horizontally long rectangle is set. The image in the image acquisition area includes a plurality of pixel signals arranged in a two-dimensional matrix. As illustrated in FIG. 17, the image acquisition area IM1 can be two-dimensionally divided into a plurality of divided regions DV1 to DV25 so that each of the divided regions DV1 to DV25 contains one or more pixel signals. FIG. 17 illustrates a case where the image acquisition area IM1 is divided horizontally and vertically into fifths, that is, 25 regions. FIG. 17 illustrates the image acquisition area IM1 by way of example, but the same applies to the image acquisition area IM2.

Each of the pixel signals included in the image includes, as the attribute, a Y signal indicating luminance, an R signal indicating a red (R) color component value, a G signal indicating a green (G) color component value, and a B signal indicating a blue (B) color component value. For the image to be processed, the processor 133 averages the luminance of the divided regions DV1 to DV25 to obtain luminance AVEY, and averages the red (R), green (G), and blue (B) color component values of the divided regions DV1 to DV25 to obtain color AVERGB. For the image to be processed, the processor 133 specifies a region with maximum luminance (e.g., DV18) among the divided regions DV1 to DV25, and sets the attribute of the specified region as representative value A. The representative value A includes luminance AY of the region with maximum luminance and color ARGB that is the red (R), green (G), and blue (B) color component values of the region with maximum luminance. For the image to be processed, the processor 133 specifies a region with minimum luminance (e.g., DV3) among the divided regions DV1 to DV25, and sets the attribute of the specified region as representative value B. The representative value B includes luminance BY of the region with minimum luminance and color BRGB that is the red (R), green (G), and blue (B) color component values of the region with minimum luminance. When the emission color of each of the light sources D1 to D15 is white, the attributes AVERGB, ARGB, and BRGB indicating color component values may be omitted.

Images of the image acquisition area are accumulated in the shift register as the car moves and time passes, and are reflected in the control of the line illumination. This process yields the luminance and color information of representative value A and representative value B. Similar evaluation is performed again in the next image acquisition to obtain regions with representative value A and representative value B in the next image. Dot-like bright spots such as tunnel illumination can be represented by defining a representative value A in a wide image acquisition area.

It is good in a dark area if the line illumination is turned on using the representative value A, but the representative value A may reflect a bright sky all day in the daytime, and the illumination may be turned on monotonously in almost pure white. The representative value B is used to cope with this situation.

In order to match with the experience, a feature point of luminance is extracted from the image in the image acquisition area, and the vehicle interior illumination control is adjusted to match the luminance of the feature point. If the image in the image acquisition area has no feature point, the average luminance is used to control the vehicle interior illumination.

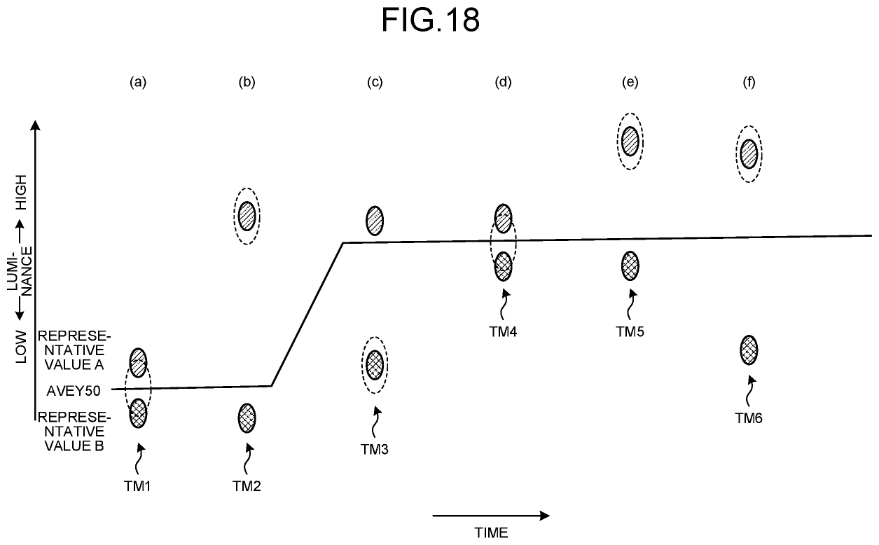

As illustrated in FIG. 18, the processor 133 may hold three types of attributes of the image to be processed, namely, the average value AVE (AVEY, AVERGB), the representative value A (AY, ARGB), and the representative value B (BY, BRGB). FIG. 18 is a diagram illustrating a process of determining the luminance of the light sources. In FIG. 18, the vertical axis represents the degree of luminance and the horizontal axis represents time. The processor 133 averages the average values AVEY of a plurality of images, for example, the average values AVEY of the latest 50 images, to obtain reference luminance AVEY50 as a reference of luminance. As illustrated in FIG. 18(a) to FIG. 18(f), if the image acquisition area remains dark, the luminance is low and AVEY50 is smaller, and if it remains bright, it is larger. The reference luminance AVEY50 indicates a reference of luminance that reflects the latest luminance tendency.

At timing TM1 illustrated in FIG. 18(a), for example, the vehicle 1 is traveling through a tunnel or on a dark night. The difference of AY and BY of the image to be processed relative to the reference luminance AVEY50 lower than a predetermined value is within a predetermined threshold range, and AY and BY of the image to be processed are close. This indicates that the image is uniformly dark with no feature points. Thus, the processor 133 generates a control value for line illumination based on AVE, as indicated by a dotted circle. Depending on AVE, a control value to turn off the illumination may be generated.

At timing TM2 illustrated in FIG. 18(b), for example, the vehicle 1 is illuminated with tunnel illumination. The difference of AY of the image to be processed relative to the reference luminance AVEY50 lower than the predetermined value is high beyond the predetermined threshold range. This indicates that the image is generally dark but has bright spots. Thus, the processor 133 generates a control value for lighting control of the light sources, based on the representative value A (AY, ARGB), as indicated by a dotted circle.

At timing TM3 illustrated in FIG. 18(c), for example, the vehicle 1 is just before exiting the tunnel. The difference of BY of the image to be processed relative to the reference luminance AVEY50 higher than the predetermined value is low below the predetermined threshold range. This indicates that the image is generally bright but has dark spots. Thus, the processor 133 generates a control value for lighting control of the light sources, based on the representative value B (BY, BRGB), as indicated by a dotted circle. This expresses “dark area in brightness”.

At timing TM4 illustrated in FIG. 18(d), for example, the vehicle 1 exits the tunnel and passes through a uniform sky. The difference of AY, BY of the image to be processed relative to the reference luminance AVEY50 higher than the predetermined value is within the predetermined threshold range, and AY and BY of the image to be processed are close. This indicates that the image is uniformly bright with no feature points. Thus, the processor 133 generates a control value for lighting control of the light sources, based on the average value AVE (AVEY, AVERGB), as indicated by a dotted circle. However, the processor 133 may set the peak of the average luminance value at an intermediate level of luminance, regardless of AVEY.

At timing TM5 illustrated in FIG. 18(e), for example, the vehicle 1 is traveling near a building. The difference of AY of the image to be processed relative to the reference luminance AVEY50 higher than the predetermined value is high beyond the predetermined threshold range. This indicates that the image is generally bright but has even brighter spots. Thus, the processor 133 generates a control value for lighting control of the light sources, based on the representative value A (AY, ARGB), as indicated by a dotted circle.

At timing TM6 illustrated in FIG. 18(f), for example, the vehicle 1 is traveling to pass through the sunlight filtering through the leaves. The difference of AY of the image to be processed relative to the reference luminance AVEY50 higher than the predetermined value is high beyond the predetermined threshold range, and the difference of BY of the image to be processed is low below the predetermined threshold range. This indicates that the image is generally bright but with bright spots and dark spots. Thus, the processor 133 generates a control value for lighting control of the light sources, based on the representative value A (AY, ARGB), as indicated by a dotted circle.

As illustrated in FIG. 18(a) to FIG. 18(f), the line illumination is controlled to produce movement in various external environments with variations in brightness.

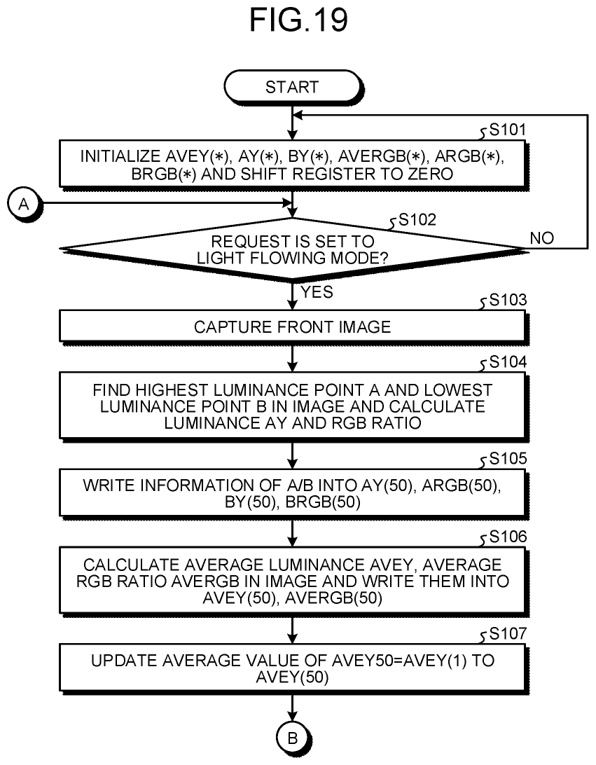

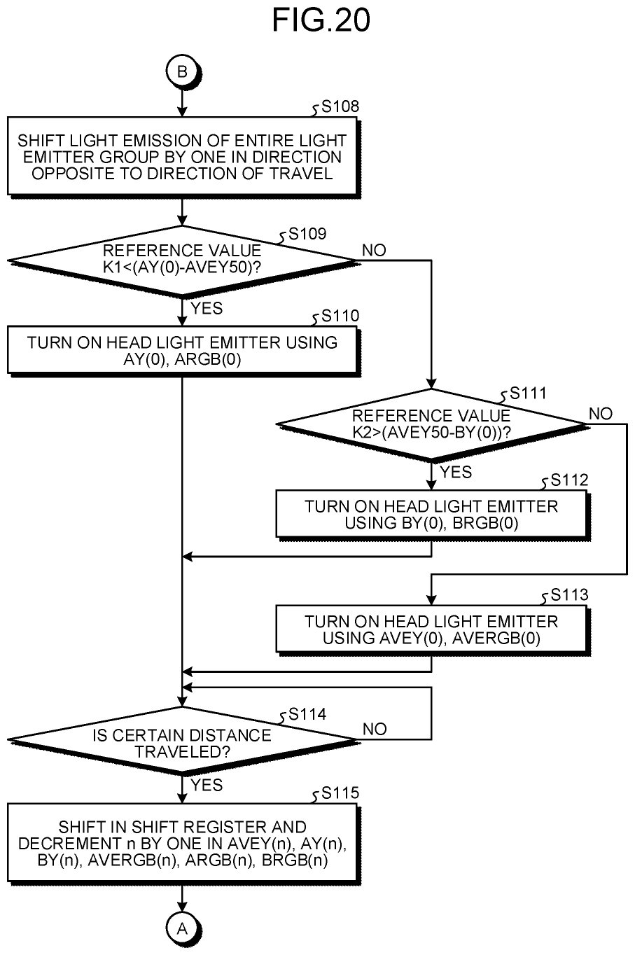

The operation flow of the vehicle 1 will now be described using FIG. 19 and FIG. 20. FIG. 19 and FIG. 20 are flowcharts illustrating the operation of the vehicle 1. FIG. 19 and FIG. 20 illustrate the process per line illumination. If there are a plurality of line illuminations and there are m image acquisition areas, the process illustrated in FIG. 19 and FIG. 20 may be performed for m in parallel.

When receiving a start request from the occupant, the vehicle control device 100 determines that the driving of the vehicle 1 is to be started and performs initial settings (S101). The vehicle control device 100 initializes parameters AVEY (*), AY (*), BY (*), AVERGB (*), ARGB (*), and BRGB (*) to zero. The number in parentheses in the parameter name is a number for identifying the image, and a smaller number represents a parameter of older data. The vehicle control device 100 initializes the registers 132 and 532 on each stage of the shift registers 131 and 531 to zero. In this case, the vehicle control device 100 does not allow light emission from each of the light emitters GR1 to GR3 of the light emitter groups 51 and 52 but may allow light emission like welcome light when the passenger gets on and off the vehicle.

The vehicle control device 100 checks a mode setting request for light emission control of the light emitter groups 51 and 52, and if setting to a light flowing mode is not requested (No at S102), the process returns to S101.

If setting to the light flowing mode is requested (Yes at S102), the vehicle control device 100 captures an image of the image acquisition area ahead, through the imaging circuit 44 (S103).

The vehicle control device 100 looks for the highest luminance point A and the lowest luminance point B in the captured image. If the highest luminance point A and the lowest luminance point B are found, the vehicle control device 100 calculates the luminance AY of the highest luminance point A and the ratio ARGB of color component values (S104).

If the latest image is the 50th image, the vehicle control device 100 writes information on the highest luminance point A in the 50th image into AY (50) and ARGB (50) and writes information on the lowest luminance point B in the 50th image into BY (50) and BRGB (50) (S105).

The vehicle control device 100 calculates the average luminance AVEY and the average RGB ratio AVERGB of the 50th image and writes them into AVEY (50) and AVERGB (50), respectively (S106).

The vehicle control device 100 updates the reference luminance AVEY50 by averaging the average luminance of the image for the 1st to 50th images as a reference of luminance (S107, B).

n=0 is data used to turn on the head of the line illumination. When the vehicle 1 passes through the location of the data, the data is discarded.

The vehicle control device 100 shifts the control value of light emission of the entire light emitter group by one in a direction opposite to the direction of travel when viewed from inside the cabin 46 (S108). Although the control value of light emission is described as being shifted by one, the control value is not necessarily a control value of one physical light source and may be a control value per unit of control, that is, for each light emitter. The process of averaging the control values among a plurality of units of control may be performed to smooth out color and light intensity variations between the preceding and subsequent control circuits.

The vehicle control device 100 compares the difference of the highest luminance from the reference luminance (AY(0)−AVEY50) with a reference value K1, for the zeroth image. If the difference of the highest luminance from the reference luminance (AY(0)−AVEY50) exceeds the reference value K1 (Yes at S109), the vehicle control device 100 determines that the point A should be reflected in the lighting control and performs lighting control of the head light source using AY(0) and ARGB(0) (S110).

If the difference of the highest luminance from the reference luminance (AY(0)−AVEY50) is equal to or less than the reference value K1 (No at S109), the vehicle control device 100 compares the difference of the lowest luminance from the reference luminance (AVEY50−BY(0)) with the reference value K2, for the zeroth image. If the difference of the lowest luminance from the reference luminance (AVEY50-BY(0)) is below the reference value K2 (Yes at S111), the vehicle control device 100 determines that the point B should be reflected in the light emission control and performs lighting control of the head light source using BY(0) and BRGB(0) (S112).

If the difference of the lowest luminance from the reference luminance (AVEY50−BY(0)) is equal to or more than a reference value K2 (No at S111), the vehicle control device 100 determines that the average value should be reflected in the light emission control and performs light emission control of the head light source using AVEY(0) and AVERGB(0) (S113).

The vehicle control device 100 waits until the vehicle 1 travels a certain distance ΔL from the point at S103 (No at S114), and when the vehicle 1 travels the certain distance ΔL (Yes at S114), the vehicle control device 100 shifts the register on each stage of the shift register by one. In other words, n in the parameters AVEY(n), AY(n), BY(n), AVERGB(n), ARGB(n), and BRGB(n) is decremented by one (S115). When the “certain distance” to be traveled is linked with the amount of one physical shift of the light emitter by shifting of the unit of light emission control, the light can flow smoothly in conjunction with change in the ambient light.

Subsequently, the vehicle control device 100 returns the process to S102 (A) and repeats the process after S2.

As described above, in the second embodiment, in the vehicle 1, a plurality of light emitters GR1 to GR3 are disposed in a line along the direction of travel on the ceiling of the cabin 46, and the respective light emission states of the light emitters GR1 to GR3 are controlled in accordance with an image captured in front of the body 43. With this configuration, an illumination environment matching the view above can be implemented real-time on the ceiling of the cabin 46, and a sense of speed, a sense of immersion, and realistic sensation can be enhanced for the driving of the vehicle 1. The entertainment feature in the cabin 46 therefore can be enhanced.

The imaging circuit 44 may be disposed at any position other than the +X and +Z sides in the cabin 46 at which images in the image acquisition areas IM1 and IM2 can be captured, and may be disposed outside the cabin 46. A camera disposed in the cabin 46 for other purposes may be used as the imaging circuit 44. For example, a dashboard camera or a camera for advanced driver assistance systems (ADAS) may be used.

The illumination circuit 45 may have one light emitter group or three or more light emitter groups. When the illumination circuit 45 has three or more light emitter groups, the imaging circuit 44 may be capable of capturing images in three or more image acquisition areas corresponding to the three or more light emitter groups. The imaging circuit 44 may have one camera 44a capable of capturing images in three or more image acquisition areas, or may have three or more cameras 44a capable of individually capturing images in three or more image acquisition areas. Three or more cameras 44a may be aligned along the Y direction at a position on the +X and +Z sides in the cabin 46.

As a first modification of the second embodiment, if the vehicle 1 can acquire map information on a certain object on the roadside ahead, map information may be further reflected in illumination control in the cabin 46. The map information is information in which the geographic location of an object and the attributes such as color and brightness of the object on the roadside are associated with each other for a plurality of objects.

In the vehicle 1, the vehicle control device 100 receives map information from a cloud server or the like at a predetermined timing via the communication device 9 illustrated in FIG. 12 and stores the map information temporarily in the RAM 103 (see FIG. 12) via the communication IF 108. The vehicle control device 100 refers to the map information and grasps the geographic location of an object. For the image acquisition area, the vehicle 1 captures an image of an object on the roadside ahead, using the imaging circuit 44. The object on the roadside may be a fixed object present along the road, such as tree, historic building, tunnel wall, or streetlight. The map information may be stored in the ROM 104 (see FIG. 12) in advance, instead of being received and acquired from a cloud server or the like.

In the vehicle 1, the vehicle control device 100 sequentially receives GPS signals through the GPS sensor 47, sequentially determines the current location of the vehicle 1 using the GPS IF 106, and sequentially corrects the current location with the vehicle speed determined using the vehicle speed IF 107. The vehicle control device 100 makes a change in accordance with the map information when generating a control value for the light emitter groups 51 and 52 in accordance with the images captured for the image acquisition areas IM1 and IM2. When it is determined that the vehicle 1 has reached the geographic location of an object, the vehicle control device 100 specifies an attribute such as color and brightness of the object corresponding to the geographic location in the map information. The vehicle control device 100 changes the control value of the light emitter groups 51 and 52 based on the captured image, in accordance with the attribute specified from the map information. With this configuration, the light emission control of each of the light emitters GR1 to GR3 of the light emitter groups 51 and 52 can be further matched to an object on the roadside, and a sense of immersion and realistic sensation can be further enhanced for the driving of the vehicle 1.

The vehicle control device 100 may reflect the characteristic colors of the surrounding landscape in the vehicle. For example, if the object is a tree, the vehicle control device 100 controls the emission color of the light emitters GR1 to GR3 to the color of green or autumn leaves. If the object is a townscape or historic building, the vehicle control device 100 controls the emission color of the light emitters GR1 to GR3 to the color of wall or roof. The vehicle control device 100 performs control to darken the brightness of the light emitters GR1 to GR3 when the vehicle 1 enters a tunnel, and brighten the brightness of the light emitters GR1 to GR3 in response to the vehicle 1 passing through a streetlight after dark.

In the vehicle 1, the vehicle control device 100 may determine, for each object on the roadside, whether the control value of the light emitter groups 51 and 52 generated from the captured image by the imaging circuit 44 is to be used as it is, or the control value is to be changed in accordance with map information. For example, the objects for which the control value is to be used as it is are trees, and the objects for which the control value is to be changed are tunnels, streetlights, townscapes, and historic buildings. Since the vehicle 1 can sequentially change the attribute specified from the map information depending on the weather, date and time of day, and events, a variety of responses are possible, such as creating a sense of the season and changing colors depending on the time of day when the vehicle passes. The vehicle control device 100 can acquire roadside map information, for example, season and weather of autumn leaves that can be seen through the vehicle windows on the road. In addition to capturing the luminance and color of the image acquisition area with the camera of the imaging circuit 44, the vehicle 1 can detect trees visible through the vehicle windows as objects and, assuming that the trees uniformly turn red, based on the roadside map information, the vehicle 1 allows red or yellow color to flow in the vehicle to match with the location of the trees visible through the vehicle windows. Similarly, the vehicle 1 can allow blue and white color to flow when a snowy tree or blue sky is seen through the vehicle windows.

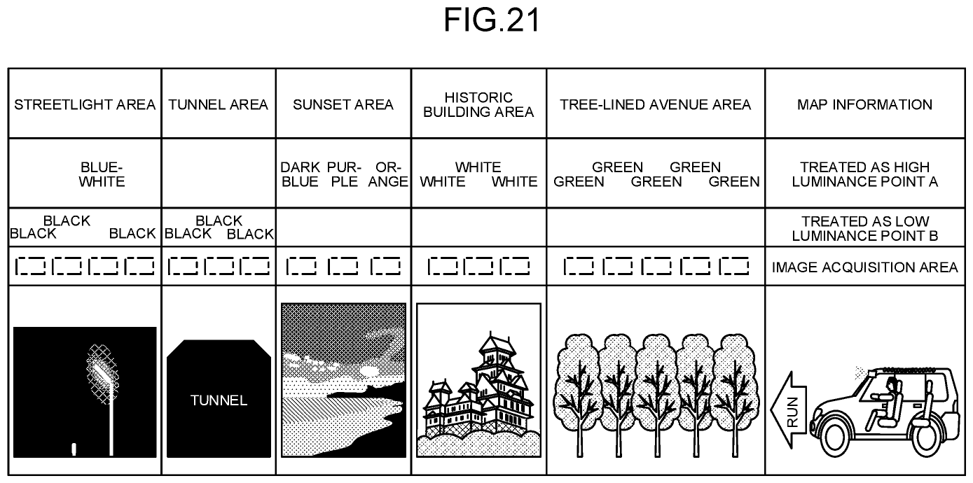

In this case, the control of luminance and the like in accordance with the map information may be combined with the control of luminance and the like as illustrated in FIG. 17 to FIG. 20. AVEY and AVERGB may be similar to those in the control in FIG. 17 to FIG. 20, and AY, ARGB and BY, BRGB may be replaced with colors in accordance with the attribute specified from the map information. The control of luminance using the map information may be performed, for example, as illustrated in FIG. 21. FIG. 21 is a diagram illustrating control of a plurality of light emitters in accordance with images in the image acquisition areas and map information in the first modification of the second embodiment.

The vehicle control device 100 changes the values of AY and BY specified from the captured image to sufficiently large values relative to the reference values K1 and K2 so that the colors treated as high luminance point A and low luminance point B are reflected in the light emission control of the light emitter groups 51 and 52.

In FIG. 21, when the vehicle 1 reaches a “street light area”, illumination control using the captured image is combined with illumination control using map information+GPS. For four points in the “streetlight area,” the vehicle 1 sets control values treated as high luminance point A to none, none, blue-white, and none and sets control values treated as low luminance point B to black, black, none, and black. “None” indicates that there is no control value and the value of high luminance point A or low luminance point B acquired by the camera is used as it is.

When the vehicle 1 reaches the “tunnel area”, illumination control is performed using map information+GPS. For three points in the “tunnel area”, the vehicle 1 sets the control values treated as high luminance point A to none, none, none, and sets the control values treated as low luminance point B to black, black, black.

When the vehicle 1 reaches the “sunset area” during early evening hours on a sunny day, illumination control is performed using map information+GPS+weather+date and time+time of day. For three points in the “tunnel area”, the vehicle 1 sets the control value treated as high luminance point A to dark blue, purple, orange, and sets the control value treated as low luminance point B to none, none, none.

When the vehicle 1 reaches a “historic building area” during daytime hours, illumination control is performed using map information+GPS+time of day. For three points in “historic building area”, the vehicle 1 sets the control value treated as high luminance point A to white, white, white, and sets the control value treated as low luminance point B to none, none, none.

When the vehicle 1 reaches a “tree-lined avenue area” during daytime hours, illumination control using the captured image is combined with illumination control using map information+GPS. For five points in the “tree-lined avenue area”, the vehicle 1 sets the control value treated as high luminance point A to green, green, green, green, green and sets the control value treated as low luminance point B to none, none, none, none, none, none.

The vehicle control device 100 may update the object information in the map information received from a cloud server or the like via the communication device 9 with the information of an object detected when the vehicle actually runs, and then reflect the updated object information in the light emission control of the light emitter groups 51 and 52 when the vehicle runs on the roadside with the object. For example, when color target objects increase or decrease or dislocated due to construction, or the visible color of objects changes due to weather fluctuations, the vehicle control device 100 can update the map information to a color more appropriate for the objects.

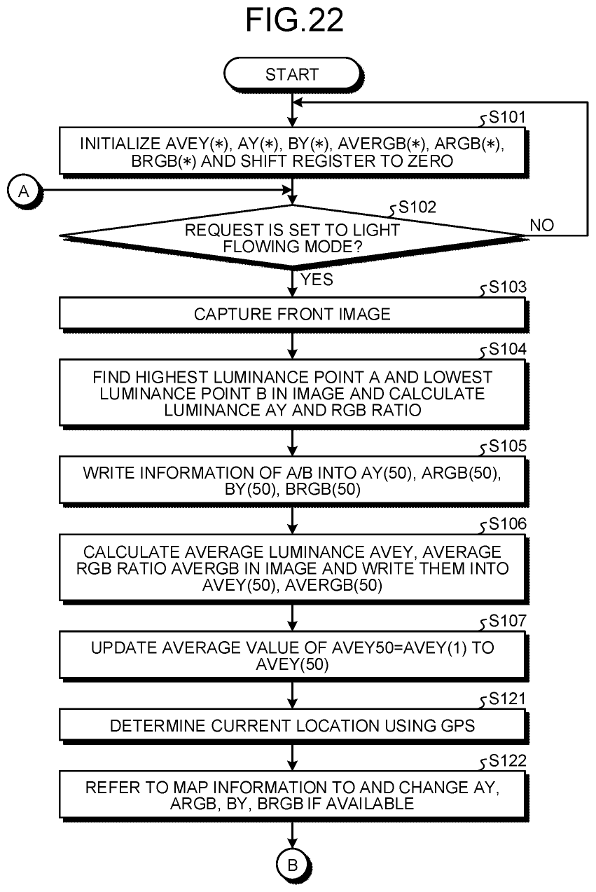

As illustrated in FIG. 22, the operation of the vehicle 1 different from that in the second embodiment in the following respects may be performed. FIG. 22 is a flowchart illustrating the operation of the vehicle 1 according to the first modification of the second embodiment.

After the process at S1 to S7 is performed, the vehicle control device 100 receives GPS signals through the GPS sensor 47, determines the current location of the vehicle 1 with the GPS IF 106, and corrects the current location with the vehicle speed determined with the vehicle speed IF 107 (S121).

The vehicle control device 100 refers to the map information and changes AY, ARGB, BY, and BRGB, if available (S122, B). In other words, when it is determined that the vehicle 1 has reached the geographic location of an object, the vehicle control device 100 specifies the attribute such as color and brightness of the object corresponding to the geographic location in the map information. The vehicle 1 overwrites AY, ARGB, BY, and BRGB with AY, ARGB, BY, and BRGB in accordance with the attribute specified from the map information. The vehicle control device 100 then performs the process after S108.

The vehicle control device 100 may skip the process at S121 and S122 if there is no map information, or if the map information is not enabled due to seasonal, time of day, or weather factors.

In this way, in the first modification of the second embodiment, the control values of the light emitter groups 51 and 52 based on the captured images are changed in accordance with the attribute specified from the map information. This process enables the light emission control of the light emitter groups 51 and 52 to be matched with the object on the roadside and can further enhance a sense of immersion and realistic sensation for the driving of the vehicle 1.

As a second modification of the second embodiment, the light emission control of the light emitter groups 51 and 52 may be deactivated in a steady state, and the light emission control of the light emitter groups 51 and 52 may be started when the geographic location of the vehicle 1 comes within a highlight point. The geographic location of the highlight point may be included in the map information. The vehicle control device 100 may acquire information on the geographic location of the highlight point in cooperation with the navigation system of the vehicle 1. For example, when it is detected that the sightseeing spot guidance function of the navigation system has been turned ON, the vehicle control device 100 may determine that the vehicle comes within the highlight point and start light emission control of the light emitter groups 51 and 52. Alternatively, the vehicle control device 100 may start light emission control of the light emitter groups 51 and 52 in synchronization with a start signal of sightseeing commentary voice of the navigation system. In other words, the vehicle control device 100 may determine that the vehicle comes within the highlight point and start light emission control of the light emitter groups 51 and 52, in response to activation of a start signal of sightseeing commentary voice of the navigation system.

This process clarifies the location where the vehicle 1 should perform light emission control. In other words, the vehicle 1 does not emit light from each of the light emitters GR1 to GR3 until it reaches the highlight point, and performs light emission control of each of the light emitters GR1 to GR3 when it reaches the highlight point. This process can produce effects such as surprising the occupants when light is emitted, and attracting their interest in the explanation of the location.

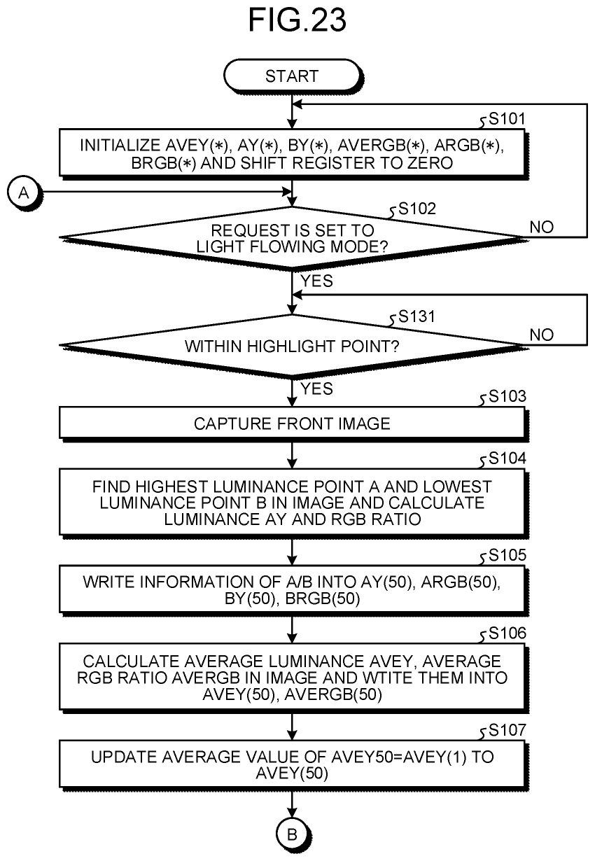

As the second modification of the second embodiment, as illustrated in FIG. 23, the operation of the vehicle 1 different from that in the second embodiment in the following respects may be performed. FIG. 23 is a flowchart illustrating the operation of the vehicle 2 according to the first modification of the second embodiment.

If setting to the light flowing mode is requested (Yes at S102), the vehicle control device 100 waits (No at S131) until the geographic location of the vehicle 1 comes within the highlight point. If the geographic location of the vehicle 1 comes within the highlight point (Yes at S131), the vehicle control device 100 performs the process after S103. Although not illustrated in the drawing, the vehicle control device 100 may determine whether the vehicle 1 has come out of the highlight point after S15. The vehicle control device 100 may continue the light emission control of the light emitter groups 51 and 52 when the vehicle 1 is within the highlight point, and suspend the light emission control of the light emitter groups 51 and 52 when the vehicle 1 comes out of the highlight point. Then (A), the vehicle control device 100 may return the process to S2.

In this way, in the second modification of the second embodiment, the control values of the light emitter groups 51 and 52 based on the captured images are started in response to the geographic location of the vehicle 1 coming within the highlight point. This process can produce a surprise to the occupants when light is emitted and can further enhance a sense of immersion and realistic sensation for the driving of the vehicle 1.

### Third Embodiment

A third embodiment will be described using the drawings.

### Configuration Example of Vehicle

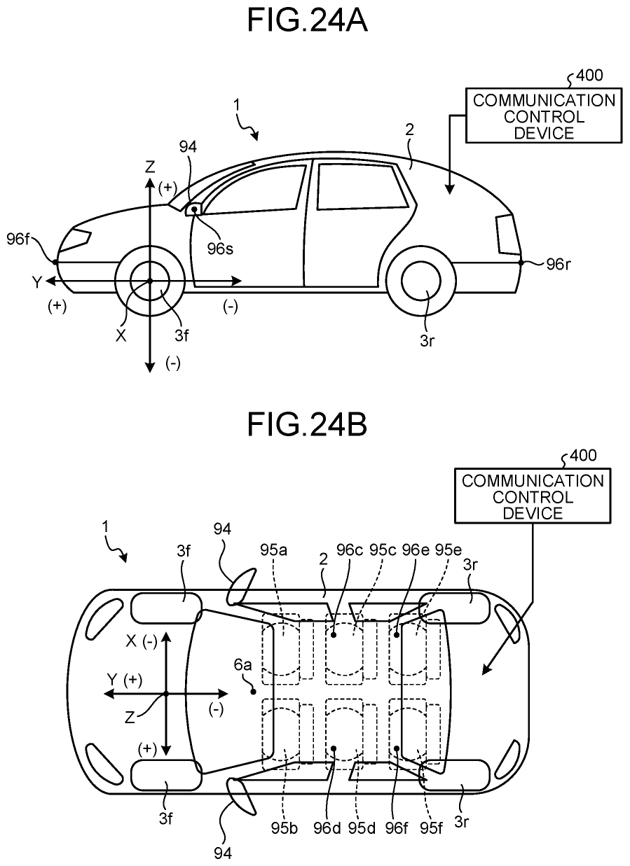

FIGS. 24A and 24B are schematic diagrams illustrating an exemplary vehicle 1 equipped with a communication control device 400 according to the third embodiment. FIG. 24A is a side view of the vehicle 1 and FIG. 24B is a top view of the vehicle 1.

As illustrated in FIGS. 24A and 24B, the vehicle 1 has a body 2 and two pairs of wheels 3 (a pair of front tires 3f and a pair of rear tires 3r) arranged on the body 2 along the vehicle length direction (±Y direction) of the body 2. A pair of two front tires 3f and a pair of two rear tires 3r are each arranged along the vehicle width direction (±X direction orthogonal to the ±Y direction) of the body 2.

The vehicle 1 includes a pair of door mirrors 94 at both ends in the ±X direction of the body 2 at positions closer to the front tires 3f in the ±Y direction of the body 2 and at a predetermined height in the vehicle height direction (±Z direction orthogonal to the ±X and ±Y directions).

The vehicle 1 includes a plurality of seats 95a to 95f in the interior of the body 2. The seats 95a and 95b are arranged closer to the front tires 3f side by side in the ±X direction. The seats 95c and 95d are arranged between the front tires 3f and the rear tires 3r side by side in the ±X direction. The seats 95e and 95f are arranged closer to the rear tires 3r side by side in the ±X direction. The seat 95c is arranged behind the seat 95a, the seat 95d is arranged behind the seat 95b, the seat 95e is arranged behind the seat 95c, and the seat 95f is arranged behind the seat 95d. The number and arrangement of the seats 95 in the vehicle 1 is not limited to the example in FIGS. 24A and 24B.

The vehicle 1 includes a plurality of communication devices 96a to 96f on the inner walls of the body 2. The communication devices (96a, 996c, 96d, 96e, 96f) for use in communication between occupants in the vehicle are arranged near the seats.

As for the communication devices (96a, 96c, 96d, 96e, 96f), for example, the communication device 96a is arranged in front of the seats 95a and 5b, the communication device 96c is arranged to the right of the seat 95c, the communication device 96d is arranged to the left of the seat 95d, the communication device 96e is arranged to the right of the seat 95e, and the communication device 96f is arranged to the left of the seat 95f. The communication devices (96a, 96c, 96d, 96e, 96f) are used for communication between the occupants.

In the present description, the end surface on the front tire 3f side of the body 2 may be referred to as the front surface. The end surface on the rear tire 3r side of the body 2 may be referred to as the rear surface. Both end surfaces in the ±X direction of the body 2 may be referred to as the side surfaces. When a person is seated on any of the seats 95a to 95f in the vehicle 1, the side surface on the right side may be referred to as the right side surface and the side surface on the left side may be referred to as the left side surface.

In the present description, the direction toward the left side surface of the body 2 is the +X direction, and the direction toward the right side surface is the −X direction. The direction toward the front surface side of the body 2 is the +Y direction, and the direction toward the rear surface side is the −Y direction. The direction toward the top of the body 2 is the +Z direction, and the direction toward the bottom (road surface side) is the −Z direction.

In the present description, when the vehicle 1 is parked on a road surface having an ideal plane, the axis in the ±X direction (X axis) and the axis in the ±Y direction (Y axis) of the vehicle 1 are parallel to the road surface, and the axis in the ±Z direction (Z axis) of the vehicle 1 is parallel to the normal to the road surface.

The vehicle 1 can run on two pairs of wheels 3 arranged along the ±Y direction. In this case, the ±Y direction in which two pairs of wheels 3 are arranged is the traveling direction (movement direction) of the vehicle 1, and the vehicle 1 can move forward (travel in the +Y direction) or backward (travel in the −Y direction), for example by switching the gear. The vehicle 1 can also turn right and left by steering.

The communication control device 400 is mounted, for example, on the vehicle 1 and controls the communication devices 96a, 96c, 96d, 96e, and 96f. The communication control device 400 performs control of, for example, displaying various types of information on the communication control device 400 in response to the user's input. The details will be described later.

### Hardware Configuration Example of Communication Control Device

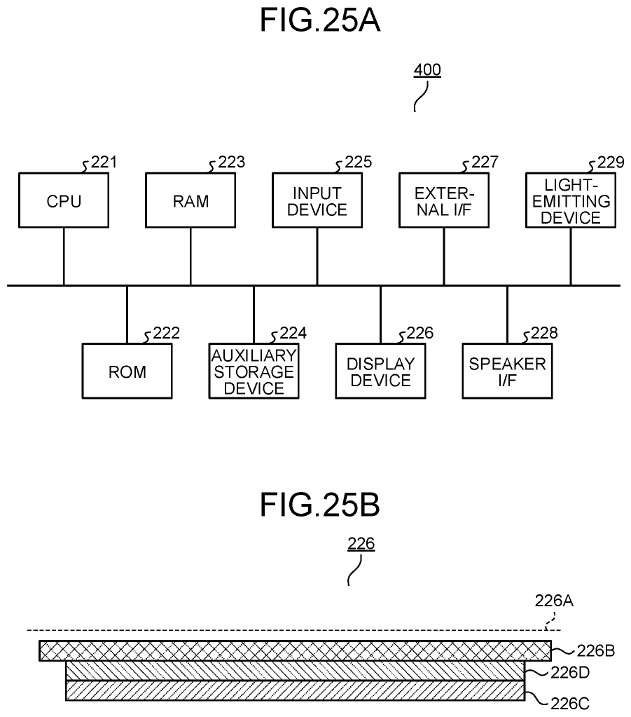

FIGS. 25A and 25B are diagrams illustrating an exemplary hardware configuration of the communication control device 400 according to the third embodiment. As illustrated in FIG. 25A, the communication control device 400 includes a central processing unit (CPU) 221, a read only memory (ROM) 222, a random access memory (RAM) 223, an auxiliary storage device 224, an input device 225, a display device 226, an external I/F 227, and a speaker I/F 228.

The CPU 221 executes a computer program to centrally control the operation of the communication control device 400 and implement various functions of the communication control device 400. The various functions of the communication control device 400 will be described later.

The ROM 222 is a nonvolatile memory and stores various data (information that is written in the manufacturing stage of the communication control device 400) including a computer program for activating the communication control device 400. The RAM 223 is a volatile memory having a work area for the CPU 221. The auxiliary storage device 224 stores various data such as computer programs executed by the CPU 221. The auxiliary storage device 224 is composed of, for example, a hard disk drive (HDD).

The input device 225 is a device for the occupant using the communication control device 400 (here, for example, the person operating the communication device) to perform various operations. The input device 225 is composed of, for example, a touch panel or hardware keys.

The display device 226 is a display that displays various types of information including icons and a seating chart. The display device 226 may be composed of, for example, a liquid crystal display, and the input device 225 and the display device 226 may be configured as one unit, for example, in the form of a touch panel.

The external I/F 227 is an interface for connecting (communicating) to external devices such as the communication devices 96a, 96c, 96d, 96e, and 96f, for example, over a local interconnect network (LIN).

The speaker I/F 228 is a device for outputting dial tone/ringing tone when a transmitted icon and seat are received.

A light-emitting device 229 is a light emitter such that the light-emitting device successively turns on so as to approach from the transmitting seat toward the communication device corresponding to the transmitted seat. The light-emitting device 229 is composed of, for example, a light emitting diode (LED).

FIG. 25B is a cross-sectional view illustrating a structure of the display device 226 of the communication control device according to the third embodiment.

The display device 226 includes an operation surface 226A that can be at least touched with a finger, a sheet 226B arranged along the operation surface 226A on the underside of the operation surface 226A, a light emission circuit (display circuit) 226C arranged along the operation surface 226A on the underside of the sheet 226B and capable of emitting visible light (predetermined light), and a touch panel circuit (detection circuit) 226D arranged between the operation surface 226A and the light emission circuit 226C along the operation surface 226A and the light emission circuit 226C and capable of detecting at least finger movement on the operation surface 226A.

The sheet 226B may be affixed to the touch panel circuit 226D with double-sided tape or adhesive, or may be printed directly. The light emission circuit 226C is an organic electroluminescence (EL) display circuit or a liquid crystal display circuit with backlight. The sheet 226B and the touch panel circuit 226D are light-transmitting and allow light emitted by the light emission circuit 226C to pass through. For example, an ultrasonic surface acoustic wave, resistive, or capacitive touch panel is used for the touch panel circuit 226D.

### Functional Example of Communication Control Device

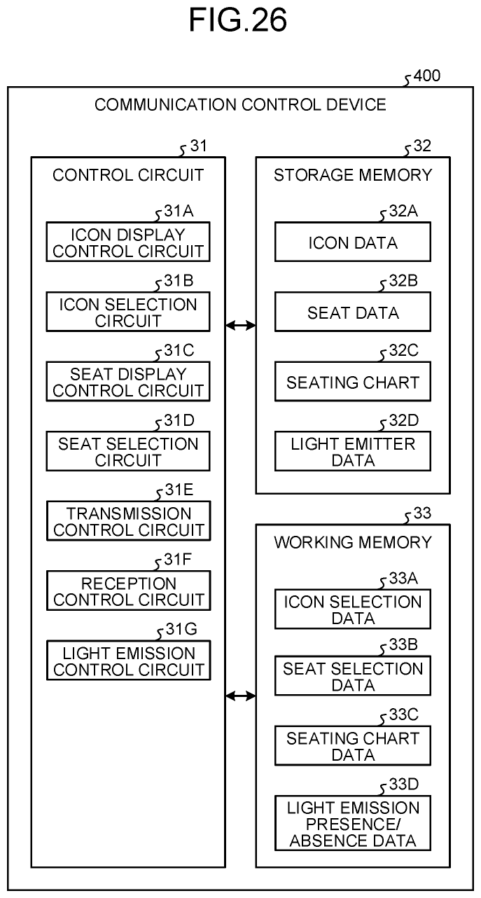

FIG. 26 is a diagram illustrating an exemplary functional configuration of the communication control device according to the third embodiment. In the example in FIG. 26, only the functions related to the present embodiment are illustrated, but the functions of the communication control device 400 are not limited to these. As illustrated in FIG. 26, the communication control device 400 includes a control circuit 31, a storage memory 32, and a working memory 33.

The control circuit 31 includes an icon display control circuit 31A, an icon selection circuit 31B, a seat display control circuit 31C, a seat selection circuit 31D, a transmission control circuit 31E, a reception control circuit 31F, and a light emission control circuit 31G.

The icon display control circuit 31A has a control function of displaying at least one icon for use in communication between the occupants on the display. The at least one icon for use in communication between occupants is icon data 32A stored in the storage memory 32. In the present example, the icon display control circuit 31A may have a function to be activated to display the icon data 32A for use in communication on the display. For the icon data 32A for use in communication, the icon data 32A may be set by default when the icon data 32A appears on the display after the communication control device 400 is activated.

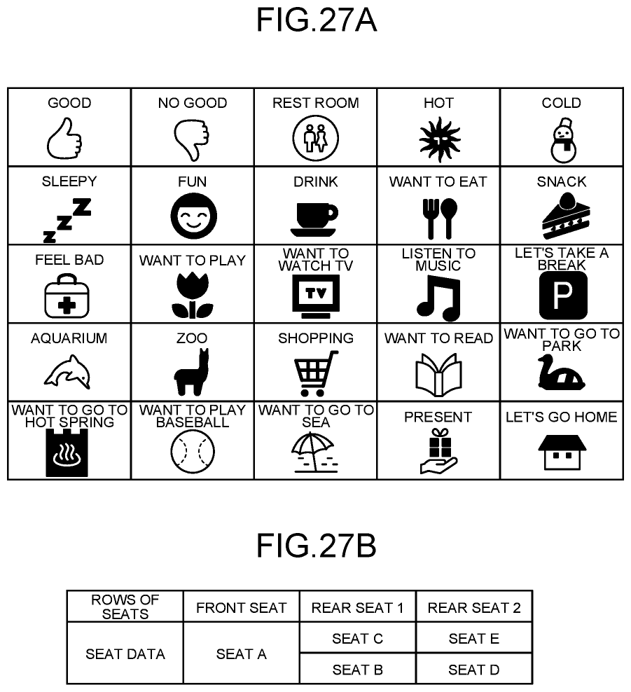

Here, FIG. 27A illustrates an example of icons. The top rows in the table indicate the meaning of icons, and the bottom rows indicate the icons indicating the meaning on the top rows. These are only examples, and the icons in the present disclosure are intended to include icons other than those in FIG. 27A.

The control function of displaying icons on the display refers to the control function of displaying the icon data 32A on the display or displaying icon selection data 33A selected by the icon selection circuit 31B in response to the user's input from the icons of icon data 32A appearing on the display.

The icon selection circuit 31B has a function of selecting one icon from among at least one icon in response to the user's input. If the user wants to transmit an icon to another occupant, the user selects one icon from among at least one icon. The icon to be selected is the icon data 32A stored in the storage memory 32, and the selected icon is stored in the icon selection data 33A stored in the working memory 33.

The seat display control circuit 31C has a control function of displaying a seating chart indicating the positions of seats on the display. The seating chart indicating the positions of seats is a seating chart 32C stored in the storage memory 32. Here, FIG. 27B illustrates an example of the seating chart indicating the positions of seats. The seating chart consists of rows of seats and seat data, and here an example of a vehicle with three rows is illustrated. These are only examples, and the seating chart in the present disclosure also includes seating charts other than that in FIG. 27B.

The seat selection circuit 31D has a function of selecting a seat serving as a transmission destination of the icon selected by the icon selection circuit from the seating chart in response to the user's input. The seat serving as a transmission destination of the icon is seat data 32B stored in the storage memory 32, and the selected seat is stored in seat selection data 33B stored in the working memory 33. The seat of a transmission source transmitted by the user is stored in the seat selection data 33B.

The transmission control circuit 31E has a control function of transmitting an icon to the communication device corresponding to the seat selected by the seat selection circuit 31D. The selected seat is the seat selection data 33B stored in the working memory 33, and the icon to be transmitted is icon selection data 33A stored in the working memory 33.

The reception control circuit 31F has a control function of receiving an icon on the communication device corresponding to the seat transmitted by the transmission control circuit 31E. The seat transmitted is the seat selection data 33B stored in the working memory 33, and the icon received is the icon selection data 33A stored in the working memory 33.

The light emission control circuit 31G has a light emission control function in which the light emitter successively turns on so as to approach from the transmitting seat toward the communication device corresponding to the seat transmitted by the transmission control circuit 31E. The transmitting seat and the transmitted seat are the seat selection data 33B stored in the working memory 33, and that light emission successively turns on is lighting control by light emission presence/absence data 33D stored in the working memory 33.

The process of transmitting an icon that is performed by the control circuit 230 will now be described.

### Example of Transmission Process by Communication Control Device

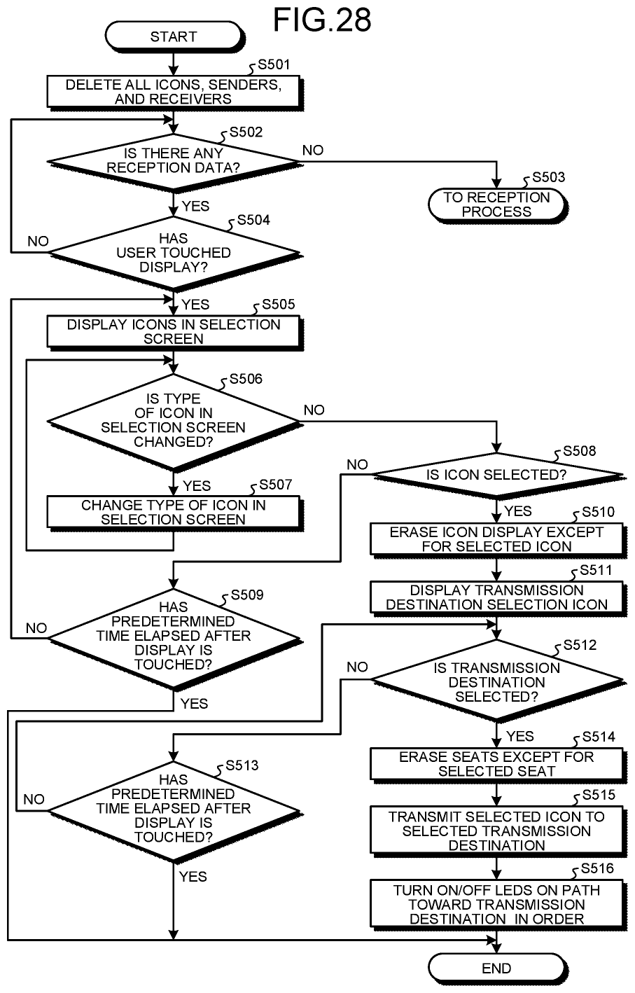

FIG. 28 is a flowchart illustrating an example of the process of transmitting icon selection data 33A that is performed by the control circuit 230 in the present embodiment.

First, the icon display control circuit 31A and the seat display control circuit 31C delete the icon selection data 33A, the seat selection data 33B including sender and receiver, seating chart data 33C, and all data (step S501). When all data is deleted, the process proceeds to step S502.

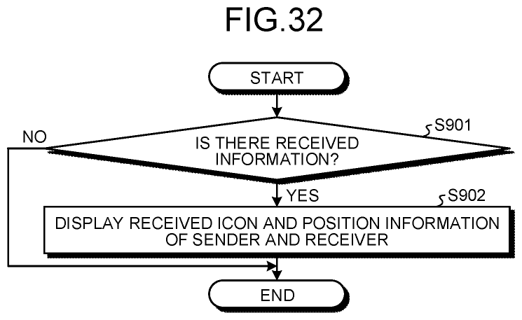

At step S502, the reception control circuit 31F determines whether there is any reception data to receive icon selection data 33A on the communication device corresponding to seat selection data 33B transmitted by the transmission control circuit 31E. If it is determined that there is reception data (No at step S502), the process proceeds to a reception process S503. The function of the reception process S503 of the control circuit 230 will be described later in FIG. 32. If it is determined that there is no reception data (Yes at step S502), the process proceeds to step S504.

At step S504, the icon display control circuit 31A determines whether the user has touched the display. If it is determined that the user has not touched the display (No at step S504), the process returns to step S502. If it is determined that the user has touched the display (Yes at step S504), the process proceeds to step S505.

At step S505, the icon display control circuit 31A displays icon data 32A so that one icon selection data 33A is selected from among at least one icon data 32A in response to the user's input. When icon data 32A is displayed, the process proceeds to step S506.

At step S506, it is determined whether the user changes the type of icon data 32A that the user wants to transmit. If it is determined that the user changes the type of icon data 32A (Yes at step S506), the process proceeds to step S507. At step S507, the icon display control circuit 31A changes the type of icon data 32A, and the process proceeds to step S506. If it is determined that the user does not change the type of icon data 32A (No at step S506), the process proceeds to step S508.

At step S508, it is determined whether the icon selection circuit 31B has selected one icon selection data 33A from among at least one icon data 32A in response to the user's input. If it is determined that the user has not selected icon data 32A (No at step S508), the process proceeds to step S509.

At step S509, the icon display control circuit 31A determines whether a predetermined time has elapsed after the display is touched. If it is determined that the predetermined time has elapsed (Yes at step S509), the process of transmitting icon selection data 33A ends, without the user transmitting icon selection data 33A. If it is determined that the predetermined time has not elapsed (No at step S509), the process proceeds to step S505. If it is determined that the user has selected icon data 32A (Yes at step S508), the process proceeds to step S510.

At step S510, the icon display control circuit 31A performs a process of erasing icon data 32A except for one icon selection data 33A selected from among at least one icon data 32A, in response to the user's input. When the display is erased except for the selected icon selection data 33A, the process proceeds to step S511.

At step S511, the seat display control circuit 31C performs control of displaying the seating chart 32C indicating the positions of seats on the display. When the seating chart 32C is displayed on the display, the process proceeds to step S512.

At step S512, it is determined whether the seat selection circuit 31D selects seat data 32B serving as a transmission destination of the icon selection data 33A selected by the icon selection circuit 31B from the seating chart 32C, in response to the user's input. If it is determined that seat data 32B is not selected (No at step S512), the process proceeds to step S513.

At step S513, it is determined whether a predetermined time has elapsed after the seat selection circuit 31D touches the display. If it is determined that the predetermined time has elapsed (Yes at step S513), the process of transmitting icon selection data 33A ends, without the user transmitting icon selection data 33A. If it is determined that the predetermined time has not elapsed (No at step S513), the process proceeds to step S512. If it is determined that seat data 32B is selected (Yes at step S512), the process proceeds to step S514.

At step S514, in response to user's input, the seat selection circuit 31D erases seat data 32B from the seating chart data 33C, except for the seat selection data 33B that is a transmission destination of icon selection data 33A selected by the icon selection circuit. When the seats are erased except for the selected seat, the process proceeds to step S515.

At step S515, the transmission control circuit 31E performs a process of transmitting icon selection data 33A to the communication device corresponding to the seat selection data 33B selected by the seat selection circuit 31D. When the process of transmitting the icon selection data 33A to the communication device corresponding to the selected seat selection data 33B is performed, the process proceeds to step S516.

At step S516, the light emission control circuit 31G performs a process for the light emitter arranged between the communication devices so that the light emitter successively turns on so as to approach from the transmitting seat selection data 33B toward the communication device corresponding to the seat selection data 33B transmitted by the transmission control circuit 31E. When the process is performed so that the light emitter successively turns on so as to approach from the transmitting seat selection data 33B toward the communication device corresponding to the seat selection data 33B transmitted by the transmission control circuit 31E, the process of transmitting icon selection data 33A that is performed by the control circuit 230 is completed.

### Example of Display Format in Transmission Process on Display

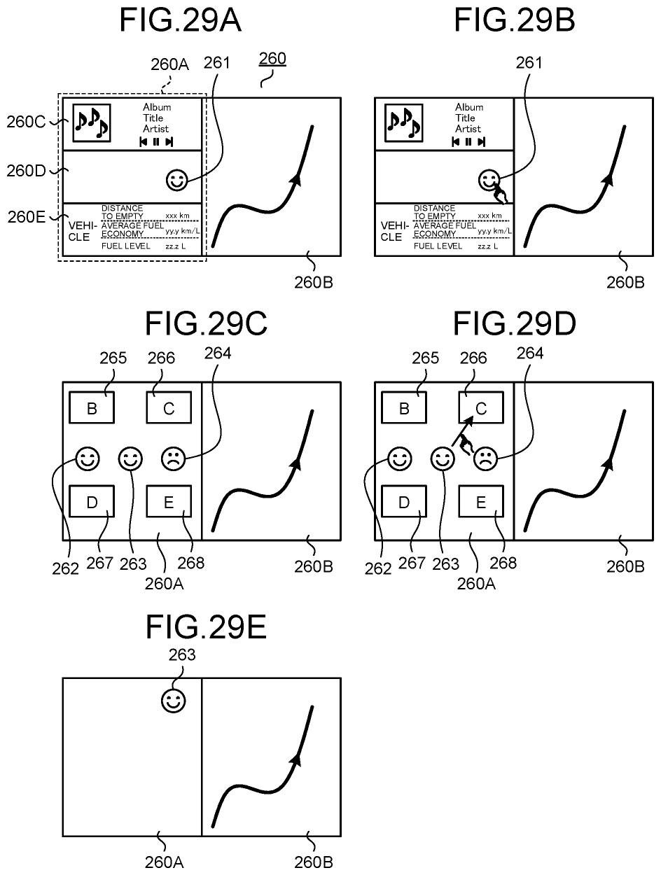

Referring now to FIGS. 29A to 29E, FIGS. 30A to 30D, and FIGS. 31A to 31C, the user's screen transition in the icon transmission process on the display of the communication device will be described.

As illustrated in FIG. 29A, a center display provided in the instrument panel in the vehicle will be described by way of example. A screen 260 is a screen appearing on the display in front of the occupant in the front seat, and the display is a center display in the instrument panel of the vehicle, as an example. The screen 260 may be a screen displayed in front of and between the occupants in the front seats.

The screen 260 is formed of a liquid crystal panel and an electrostatic touch panel. A screen 260A mainly displays information about infotainment. For example, a screen 260C within the screen 260A displays information about music, a screen 260D displays information on an icon 261 about communication, and a screen 260E displays information about the vehicle.

A screen 260B mainly displays information necessary for driving, such as navigation. In the present disclosure, since it is assumed the driver is driving a right-hand drive vehicle, the screen 260 displays information about infotainment in an area of the screen 260A far from the driver's seat and displays information necessary for driving in the screen 260B closer to the driver's seat. Information necessary for driving is displayed on the screen 260B so that the driver requires less eye movement and the driving is not interrupted.

As illustrated in FIG. 29B, the icon 261 is displayed in the screen 260D (display), and when the user touches the icon 261 on the screen 260D (display), the icon display control circuit 31A performs a screen transition to FIG. 29C.

As illustrated in FIG. 29C, icons (262, 263, 264) are displayed in the screen 260A (display), and the icon display control circuit 31A displays icons (262, 263, 264) (icon data 32A) in the screen 260A (display) so that one icon (icon selection data 33A) is selected from among at least one icon (262, 263, 264) (icon data 32A), in response to the user's input.

Seats (265, 266, 267, 268) are displayed in the screen 260A (display), and the seat display control circuit 31C displays the seats (265, 266, 267, 268) indicating the positions of seats (seating chart 32C and seat data 32B) in the screen 260A (display). When icons (262, 263, 264) (icon data 32A) and seats (265, 266, 267, 268) (seating chart 32C and seat data 32B) are displayed in the screen 260A (display), the screen makes a transition to FIG. 29D.

As illustrated in FIG. 29D, icons (262, 263, 264) (icon data 32A) and seats (265, 266, 267, 268) (seating chart 32C and seat data 32B) are displayed in the screen 260A (display). The icon selection circuit 31B selects one icon 263 (icon selection data 33A) from among at least one icon (262, 263, 264) (icon data 32A) in response to the user's input. Then, the seat selection circuit 31D slides the finger toward a seat (seat selection data 33B) serving as a transmission destination of the icon 263 (icon selection data 33A) selected by the icon selection circuit 31B, among the seats (265, 266, 267, 268) (seating chart 32C and seat data 32B), in response to the user's input.

When the above operation is completed, the transmission control circuit 31E performs a process of transmitting the icon 263 (icon selection data 33A) to the communication device corresponding to the seat (seat selection data 33B) selected by the seat selection circuit 31D. After completion of the transmission process, the screen makes a transition to FIG. 29E.

As illustrated in FIG. 29E, the icon 263 (icon selection data 33A) is displayed in the screen 260A (display). In the present embodiment, the seat display control circuit 31C does not display the transmission destination seat position (seat selection data 33B) on the screen 260A (display) in accordance with the transmission destination seat 266 (seat selection data 33B), but may display the transmission destination seat (seat selection data 33B) in the vicinity of the icon 263 (icon selection data 33A).

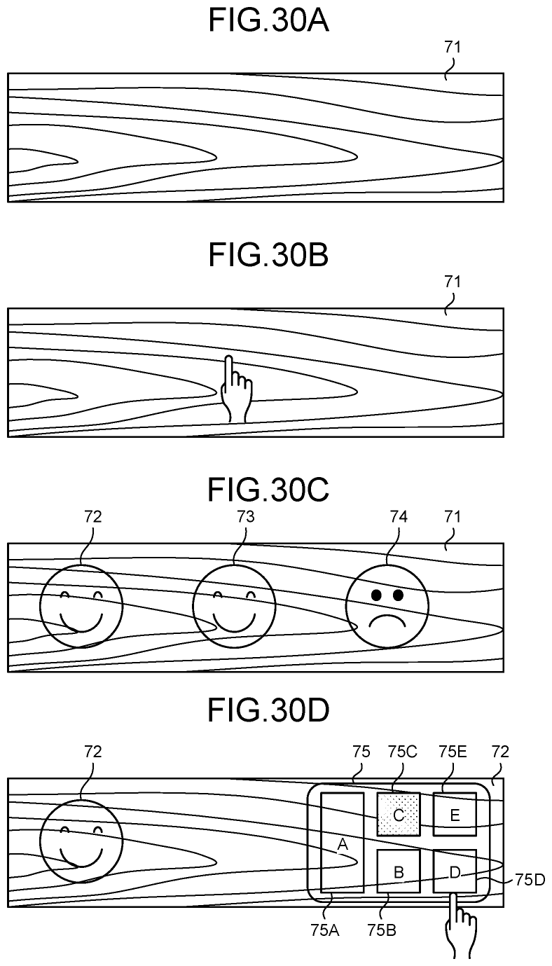

As illustrated in FIG. 30A, a screen 71 is mainly provided on a trim near the occupant in the rear seat and is, for example, a screen appearing on the display on the inner wall of the vehicle. The screen 71 is formed of a liquid crystal panel and an electrostatic touch panel and may have a decorative film on its surface layer. In the present embodiment, a decorative film with a wood-grain pattern is provided by way of example. The decorative film in the present embodiment may be thinly sliced wood or may be a resin material printed with a wood-grain pattern. The screen 71 may be provided on a trim near the occupant in the front seat.

As illustrated in FIG. 30B, the icon display control circuit 31A determines whether the user has touched the screen 71 (display) and, if it is determined that the user has touched the screen 71 (display), the screen makes a transition to FIG. 30C.

As illustrated in FIG. 30C, icons (72, 73, 74) (icon data 32A) are displayed in the screen 71 (display). The icon display control circuit 31A displays icons (72, 73, 74) (icon data 32A) in the screen 71 (display) so that one icon (icon selection data 33A) is selected from among at least one icon (72, 73, 74) (icon data 32A) in response to the user's input. When the icon selection circuit 31B selects one icon 72 (icon selection data 33A) from among at least one icon (72, 73, 74) (icon data 32A) in response to the user's input, the screen makes a transition to FIG. 30D.

As illustrated in FIG. 30D, the icon 72 (icon selection data 33A) and a seating chart 75 (seating chart 32C) are displayed in the screen 71 (display), and seats (75A, 75B, 75C, 75D, 75E) (seat data 32B) are displayed in the seating chart 75 (seating chart 32C). The seat selection circuit 31D touches the seat 75D (seat selection data 33B) serving as a transmission destination of the icon 72 (icon selection data 33A) selected by the icon selection circuit 31B, from the seating chart 75 (seating chart 32C) with a finger in response to the user's input. When the above operation is completed, the transmission control circuit 31E performs a process of transmitting the icon 72 (icon selection data 33A) to the communication device corresponding to the seat 75D (seat selection data 33B) selected by the seat selection circuit 31D. Here, the seat 75C indicates the sender's seat.

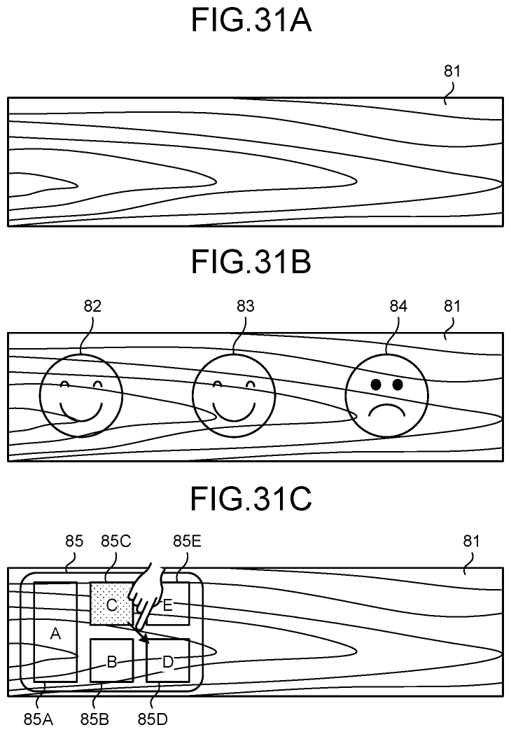

FIGS. 31A to 31C illustrate another example of the user's screen transition in the icon transmission process on the display of the communication device in FIGS. 30A to 30D.

As illustrated in FIG. 31A, a screen 81 is mainly provided on a trim near the occupant in the rear seat and is, for example, a screen appearing on the display on the inner wall of the vehicle. The screen 81 is formed of a liquid crystal panel and an electrostatic touch panel and may have a decorative film on its surface layer. In the present embodiment, a decorative film with a wood-grain pattern is provided by way of example. The decorative film in the present embodiment may be thinly sliced wood or may be a resin material printed with a wood-grain pattern.

As illustrated in FIG. 31B, icons (82, 83, 84) (icon data 32A) are displayed in the screen 81 (display). The icon display control circuit 31A displays icons (82, 83, 84) (icon data 32A) in the screen 81 (display) so that one icon (icon selection data 33A) is selected from among at least one icon (82, 83, 84) (icon data 32A) in response to the user's input. The icons (82, 83, 84) (icon data 32A) are displayed in the screen 81 (display). When the icon selection circuit 31B selects one icon 82 (icon selection data 33A) from among at least one icon (82, 83, 84) (icon data 32A) in response to the user's input, the screen makes a transition to FIG. 31C.

As illustrated in FIG. 31C, the seating chart 85 (seating chart 32C) is displayed in the screen 81 (display), and seats (85A, 85B, 85C, 85D, 85E) (seat data 32B) are displayed in the seating chart 85 (seating chart 32C). The seat selection circuit 31D slides the finger from the transmission source seat 86C (seat selection data 33B) toward the seat 85D (seat selection data 33B) serving as a transmission destination of the icon 82 (icon selection data 33A) selected by the icon selection circuit 31B from the seating chart 85 (seating chart 32C), in response to the user's input. When the above operation is completed, the transmission control circuit 31E performs a process of transmitting the icon 82 (icon selection data 33A) to the communication device corresponding to the seat 85D (seat selection data 33B) selected by the seat selection circuit 31D.

In this way, in the vehicle according to the third embodiment, the communication control device 400 includes the seat selection circuit 31D that selects seat selection data 33B serving as a transmission destination of icon selection data 33A selected by the icon selection circuit 31B from among seat data 32B in the seating chart 32C, in response to the user's input, and the transmission control circuit 31E that transmits an icon to the communication device corresponding to the seat selection data 33B selected by the seat selection circuit 31D. With this configuration, the transmission control circuit 31E transmits icon selection data 33A to seat selection data 33B, thereby facilitating non-voice communication between occupants.

Furthermore, since the screen 260A (display) that displays information on communication in the front seat is arranged far from the driver's seat, and the screen 260B closer to the driver's seat displays information necessary for driving, the driver requires less eye movement and the driving is not interrupted, while non-voice communication is facilitated between the occupants in the rear seat.

Since the screen (71, 81) (display) that displays information on communication in the rear sheet is provided on the trim near the occupant in the rear seat, the ease of operation is good for the occupant, and selecting an icon and a seat is non-text and non-voice communication, which contributes to smooth communication between occupants. Furthermore, since the screen (71, 81) (display) has a decorative film on the surface layer, a sense of unity in the vehicle is further enhanced when the screen is off, which contributes to the design quality. In addition, the occupant slides the finger from his/her seat to the seat to which he/she wants to transmit an icon. This simple operation contributes to the ease of operation for occupants.

### Example of Reception Process by Communication Control Device

The process of receiving an icon that is performed by the control circuit 230 will now be described.

FIG. 32 is a flowchart illustrating an example of the process of receiving an icon that is performed by the control circuit 230 in the present embodiment.

First, the reception control circuit 31F determines whether there is information that icon selection data 33A has been received on the communication device corresponding to seat selection data 33B transmitted by the transmission control circuit 31E (S901). If it is determined that no information has been received (No at step S901), the process of receiving icon selection data 33A ends without receiving icon selection data 33A. If it is determined that information has been received (Yes at step S901), the process proceeds to step S902.

Next, at step S902, the seat display control circuit 31C performs a process of displaying the seat position including the transmitted seat selection data 33B and the transmitted seating chart data 33C on the display, in accordance with the transmitted seat selection data 33B. The icon display control circuit 31A performs a process of displaying the icon selection data 33A on the display in accordance with the transmitted icon selection data 33A. When the above process is completed, the process of receiving the icon selection data 33A that is performed by the control circuit 230 is completed (step S902).

### Example of Display Format in Reception Process on Display

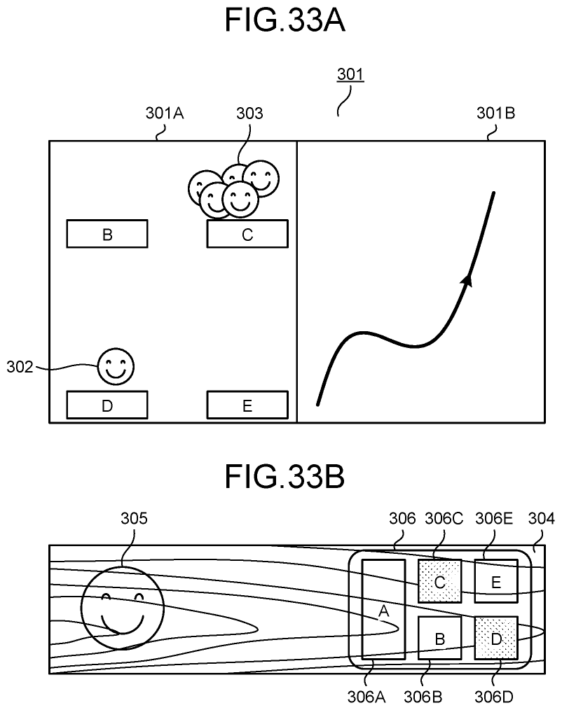

Referring now to FIGS. 33A and 33B, the user's screen transition in the icon selection data 33A receiving process on the display of the communication device will be described.

As illustrated in FIG. 33A, a screen 301 is a screen mainly displayed on the display in front of the occupant in the front seat, the display is a center display provided in the instrument panel of the vehicle, and the driver's seat is on the right side, as an example. As illustrated in FIG. 33A, a screen 301A far from the driver's seat displays information of icons (102, 103) about communication, and a screen 301B closer to the driver's seat displays information necessary for driving. Information necessary for driving is displayed on the screen 301B so that the driver requires less eye movement and the driving is not interrupted.

The seat display control circuit 31C performs a process of displaying the seat position (seat selection data 33B) including the transmitted seat selection data 33B and the transmitted seating chart data 33C on the screen 301A (display), in accordance with the transmitted seat selection data 33B. The icon display control circuit 31A performs a process of displaying icons (102, 103) (icon selection data 33A) on the screen 301A (display) in accordance with the transmitted icons (102, 103) (icon selection data 33A). When the above process is completed, the process of receiving the icon selection data 33A that is performed by the control circuit 230 is completed. Here, an icon 302 is icon selection data 33A transmitted from the seat D, and an icon 303 includes a plurality of icon selection data 33A transmitted from the seat C, which means that a number of icons are transmitted, and the icon selection data 33A may be superimposed on each other.

As illustrated in FIG. 33B, a screen 304 is mainly provided on a trim near the occupant in the rear seat and is, for example, a screen appearing on the display on the inner wall of the vehicle. The screen 304 is formed of a liquid crystal panel and an electrostatic touch panel and may have a decorative film on its surface layer. In the present embodiment, a decorative film with a wood-grain pattern is provided by way of example. The decorative film in the present embodiment may be thinly sliced wood or may be a resin material printed with a wood-grain pattern. The screen 304 may be provided on a trim near the occupant in the front seat.

An icon 305 (icon selection data 33A) and a seating chart 306 (seating chart data 33C) are displayed in the screen 304, and seats (106A, 106B, 106C, 106D, 106E) (seat selection data 33B) are displayed in the seating chart 306 (seating chart data 33C). The seat display control circuit 31C performs a process of displaying the seat position (seat selection data 33B) including the transmitted seat 306C and seat 306D (seat selection data 33B) and the transmitted seating chart 306 (seating chart data 33C) on the screen 304 (display), in accordance with the transmitted seat 306C and seat 306D (seat selection data 33B). The icon display control circuit 31A performs a process of displaying the icon 305 (icon selection data 33A) on the screen 304 (display) in accordance with the transmitted icons 305 (icon selection data 33A). When the above process is completed, the process of receiving the icon selection data 33A that is performed by the control circuit 230 is completed.

In this way, in the vehicle according to the third embodiment, the communication control device 400 includes the reception control circuit 31F that receives an icon on the communication device corresponding to the seat selection data 33B transmitted by the transmission control circuit 31E. The seat display control circuit 31C displays the transmitted seat position (seat selection data 33B) on the display in accordance with the transmitted seat selection data 33B. The icon display control circuit 31A displays icon selection data 33A on the display in accordance with the transmitted icon selection data 33A. With this configuration, the reception control circuit 31F displays the transmitted seat position (seat selection data 33B) and icon selection data 33A, thereby facilitating non-voice communication between occupants.

### Example of Reply process of Communication Control Device

The process of returning an icon that is performed by the control circuit 230 will now be described.

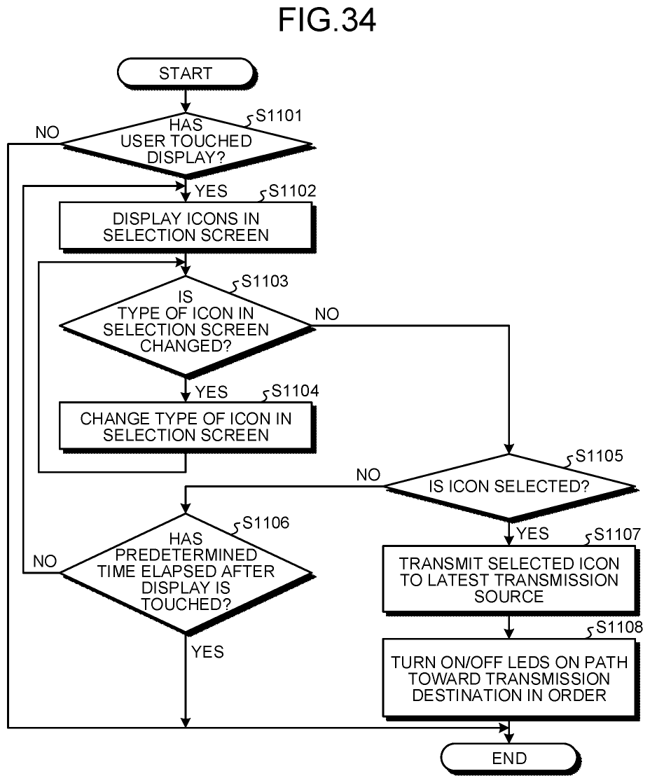

FIG. 34 is a flowchart illustrating an example of the process of returning an icon that is performed by the control circuit 230 in the present embodiment.

First, the icon display control circuit 31A determines whether the user has touched the display (step S1101). If it is determined that the user has not touched the display (No at step S1101), the process of returning icon selection data 33A ends without returning icon selection data 33A. If it is determined that the user has touched the display (Yes at step S1101), the process proceeds to step S1102.

At step S1102, the icon display control circuit 31A displays icon data 32A so that one icon selection data 33A is selected from among at least one icon data 32A in response to the user's input. When icon data 32A is displayed, the process proceeds to step S1103.

At step S1103, it is determined whether the user changes the type of icon data 32A that the user wants to transmit. If it is determined that the user changes the type of icon data 32A (Yes at step S1103), the process proceeds to step S1104. At step S1104, the icon display control circuit 31A changes the type of icon data 32A, and the process proceeds to step S1103. If it is determined that the user does not change the type of icon data 32A (No at step S1103), the process proceeds to step S1105.

At step S1105, it is determined whether the icon selection circuit 31B has selected one icon data 32A from among at least one icon data 32A in response to the user's input. If it is determined that the user has not selected icon data 32A (No at step S1105), the process proceeds to step S1106.

At step S1106, the icon display control circuit 31A determines whether a predetermined time has elapsed after the display is touched. If it is determined that the predetermined time has elapsed (Yes at step S1106), the process of transmitting icon selection data 33A ends, without the user transmitting icon selection data 33A. If it is determined that the predetermined time has not elapsed (No at step S1106), the process proceeds to step S1102. If it is determined that the user has selected icon data 32A (Yes at step S1105), the process proceeds to step S1107.

At step S1107, the transmission control circuit 31E performs a process of transmitting icon selection data 33A to the communication device corresponding to the latest transmission source seat selection data 33B obtained by the reception control circuit 31F. When the process of transmitting the icon selection data 33A to the communication device corresponding to the selected seat selection data 33B is performed, the process proceeds to step S1108.

At step S1108, the light emission control circuit 31G performs a process for the light emitter arranged between the communication devices so that the light emitter successively turns on so as to approach from the transmitting seat selection data 33B toward the communication device corresponding to the seat selection data 33B transmitted by the transmission control circuit 31E. When the process is performed so that the light emitter successively turns on so as to approach from the transmitting seat selection data 33B toward the communication device corresponding to the seat selection data 33B transmitted by the transmission control circuit 31E, the process of returning icon selection data 33A that is performed by the control circuit 230 is completed.

### Example of Display Format in Reply Process on Display

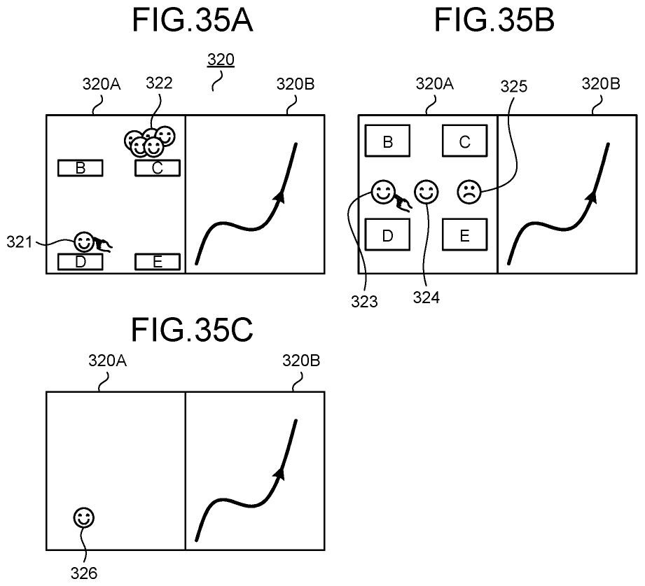

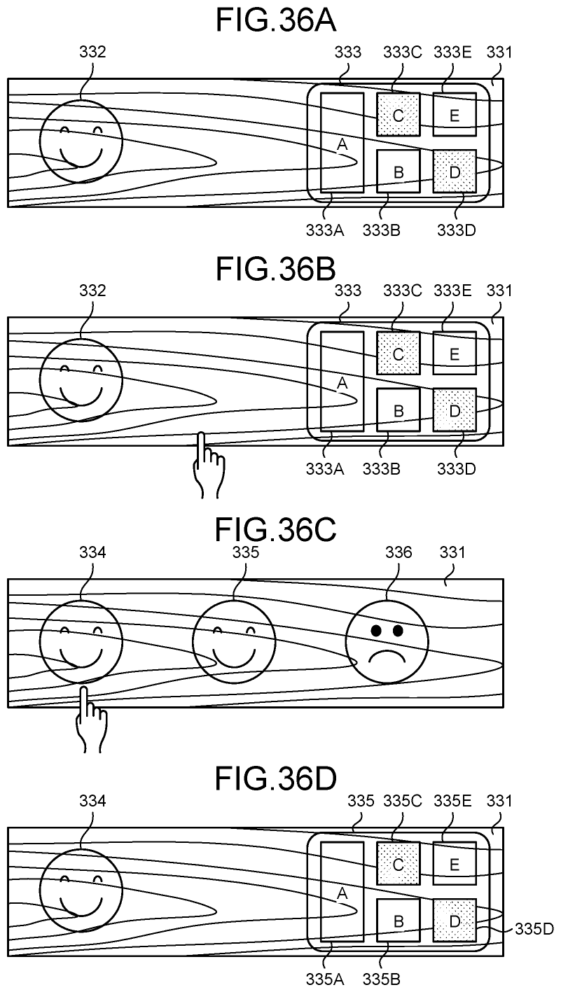

Referring now to FIGS. 35A to 35C and FIGS. 36A to 36D, the user's screen transition in the icon reply process on the display of the communication device will be described.

As illustrated in FIG. 35A, a screen 320 is a screen mainly displayed on the display in front of the occupant in the front seat, the display is a center display provided in the instrument panel of the vehicle, and the driver's seat is on the right side, as an example. As illustrated in FIG. 35A, a screen 320A far from the driver's seat displays information of icons (121, 122) about communication, and a screen 320B closer to the driver's seat displays information necessary for driving. Information necessary for driving is displayed on the screen 320B so that the driver requires less eye movement and the driving is not interrupted.

The seat display control circuit 31C performs a process of displaying the seat position (seat selection data 33B) including the transmitted seat selection data 33B and the transmitted seating chart data 33C on the screen 320A (display), in accordance with the transmitted seat selection data 33B. This is the screen after the icon display control circuit 31A performs the process of displaying icons (121, 122) (icon selection data 33A) on the screen 320A (display) in accordance with the transmitted icons (121, 122) (icon selection data 33A), that is, the screen after receiving icons (121, 122) (icon selection data 33A). Subsequently, if the icon display control circuit 31A determines whether the user has touched the screen 320 (display), the screen makes a transition to FIG. 35B. In the present example, the user is touching the icon 121 of seat D.

As illustrated in FIG. 35B, the screen 320A (display) displays icons (323, 324, 325) and seats, and the icon selection circuit 31B selects one icon 323 (icon selection data 33A) from among at least one icon (323, 324, 325) (icon data 32A) in response to the user's input. When the above operation is completed, the transmission control circuit 31E performs a process of transmitting the icon 323 (icon selection data 33A) to the communication device corresponding to the seat D (seat selection data 33B) selected by the seat selection circuit 31D. After completion of the transmission process, the screen makes a transition to FIG. 35C.

As illustrated in FIG. 35C, the icon 323 (icon selection data 33A) appears on the screen 320A (display). In the present embodiment, the seat display control circuit 31C does not display the transmitted seat position D (seat selection data 33B) on the screen 320A (display) in accordance with the transmitted seat D (seat selection data 33B), but may display the transmitted seat D (seat selection data 33B) near the icon 323 (icon selection data 33A).

FIGS. 36A to 36D illustrate a screen transition when an icon is transmitted by the seat C and the seat D receiving the icon replies to the seat C. A screen 331 is mainly provided on a trim near the occupant in the rear seat and is, for example, a screen appearing on the display on the inner wall of the vehicle. The screen 331 is formed of a liquid crystal panel and an electrostatic touch panel and may have a decorative film on its surface layer. In the present embodiment, a decorative film with a wood-grain pattern is provided by way of example. The decorative film in the present embodiment may be thinly sliced wood or may be a resin material printed with a wood-grain pattern. The screen 331 may be provided on a trim near the occupant in the front seat.

As illustrated in FIG. 36A, an icon 332 (icon data 32A) and a seating chart 333 (seating chart data 33C) are displayed in the screen 331, and seats (333A, 333B, 333C, 333D, 333E) (seat selection data 33B) are displayed in the seating chart 333 (seating chart data 33C). The seat display control circuit 31C performs a process of displaying the seat position including the transmitted seat 333C and seat 333D (seat selection data 33B) and the transmitted seating chart 333 (seating chart data 33C) on the screen 331 (display), in accordance with the transmitted seat 333C and seat 333D (seat selection data 33B). This is the screen after the icon display control circuit 31A performs the process of displaying the icon 332 (icon selection data 33A) on the screen 304 (display) in accordance with the transmitted icon 332 (icon selection data 33A), that is, the screen after receiving the icon 332 (icon selection data 33A).

As illustrated in FIG. 36B, the screen 331 makes a transition to FIG. 36C when the icon display control circuit 31A determines whether the user has touched the screen 320 (display). In the present example, the user is touching the screen 331.

As illustrated in FIG. 36C, the screen 331 (display) displays icons (334, 335, 336), and the icon selection circuit 31B selects one icon 334 (icon selection data 33A) from among at least one icon (334, 335, 336) (icon data 32A) in response to the user's input. When the above operation is completed, the transmission control circuit 31E performs a process of transmitting the icon 334 (icon selection data 33A) to the communication device corresponding to the seat 333C (seat selection data 33B) selected by the seat selection circuit 31D. After completion of the transmission process, the screen makes a transition to FIG. 36D.

As illustrated in FIG. 36D, the icon 334 (icon selection data 33A) and the seating chart 333 (seating chart data 33C) are displayed in the screen 331 (display), and a transmission source seat 335D and a transmission destination seat 335C (seat selection data 33B) are displayed in the seating chart 333 (seating chart data 33C).

In this way, in the vehicle according to the third embodiment, the communication control device 400 includes the transmission control circuit 31E that transmits the icon 334 (icon selection data 33A) selected by the icon selection circuit 31B to a communication device corresponding to the seat position (seat selection data 33B) serving as a transmission destination in response to the user's input. With this configuration, the communication device receiving icon selection data 33A transmits the icon selection data 33A to seat selection data 33B, thereby facilitating non-voice communication between occupants.

### Example of Light Emission Form in Light Emission Process of Light Emitter

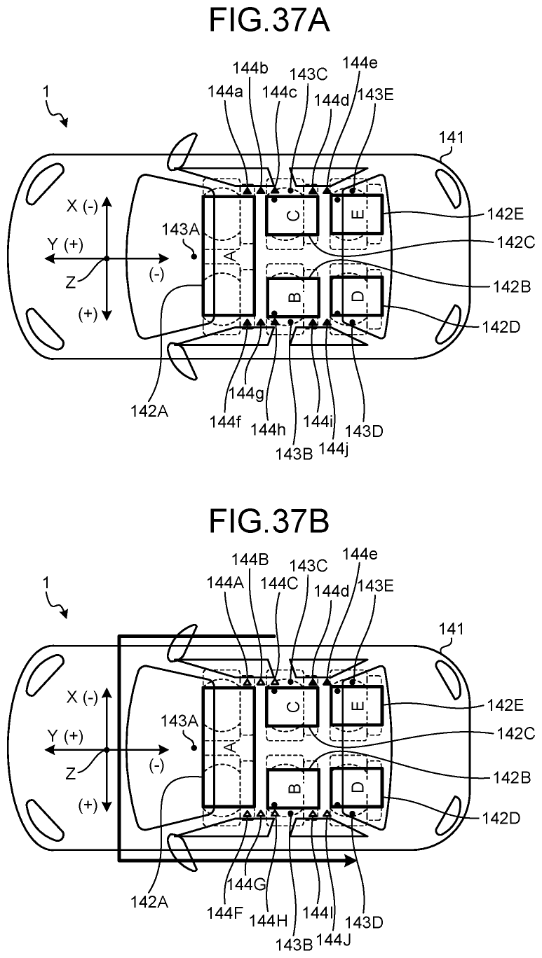

FIGS. 37A and 37B illustrate a lighting method and order of light emitters of the light-emitting device 229 by the light emission control circuit 31G of the communication control device 400 when the selected icon is transmitted for the selected seat in response to the user's input. Here, the lighting method and order of the light emitters when the occupant in a seat 142C transmits icon selection data 33A to the occupant in a seat 142D will be described.

As illustrated in FIG. 37A, in a diagram of the vehicle 141 viewed from above, the vehicle 141 has seats (142A, 142B, 142C, 142D, 142E), communication devices (143A, 143B, 143C, 143D, 143E), and light-emitting devices (144a, 144b, 144c, 144d, 144e, 144f, 144g, 144h, 144i, 144j) between each of the communication devices (143A, 143B, 143C, 143D, 143E). FIG. 37A illustrates a state before the occupant in the seat 142C transmits icon selection data 33A to the occupant in the seat 142D.

The light emitters of the light-emitting devices (144a, 144b, 144c, 144d, 144e, 144f, 144g, 144h, 144i, 144j) are provided on the inner walls of the vehicle and each may have a decorative film on the surface layer. The decorative film may be thinly sliced wood or may be a resin material printed with a wood-grain pattern.

FIG. 37B illustrates a state of the light-emitting devices (144a, 144b, 144c, 144d, 144e, 144f, 144g, 144h, 144i, 144j) illustrated in FIG. 37A after the occupant in the seat 142C transmits icon selection data 33A to the occupant in the seat 142D.

As illustrated in FIG. 37B, as a result of the occupant in the seat 142C transmitting icon selection data 33A to the occupant in seat 142D, the light-emitting devices (144a, 144b, 144c, 144d, 144e, 144f, 144g, 144h, 144i, 144j) in FIG. 37A are switched to the light-emitting devices (144A 144B, 144C, 144F, 144G, 144H, 144I, 144J), which indicates that the light-emitting devices have turned on. The light-emitting devices 144C, 144B, 144A, 144F, 144G, 144H, 144I, and 144J turn on in this order.

The light-emitting devices (144A, 144B, 144C, 144d, 144e, 144F, 144G, 144H, 144I, 144J) provided between the seat 142C and the seat 142D turn on in the +Y direction of the vehicle, from the light-emitting device 144C as the starting point to the light-emitting device 144A, then turn on from the light-emitting device 144A toward the light-emitting device 144F, along the +X direction of the vehicle, and then successively turn on in the −Y direction of the vehicle to the light-emitting device 144J as the endpoint.

In other words, in response to the user's input, with the selected icon selection data 33A and seat selection data 33B, the light emitter successively turns on so as to approach from the transmitting seat selection data 33B toward the communication device corresponding to the seat selection data 33B transmitted by the transmission control circuit 31E. The light emitters pass through the occupant's line of sight relative to the direction of travel of the vehicle and flow toward the designated seat. This contributes to the visibility of the communication devices.

In this way, in the vehicle according to the third embodiment, the display further includes a light emitter. The light emitter is arranged between each of the communication devices. The vehicle includes the light emission control circuit 31G such that the light emitter successively turns on so as to approach from the transmitting seat selection data 33B toward the communication device corresponding to the seat selection data 33B transmitted by the transmission control circuit 31E.

With this configuration, the light emitter successively turns on so as to approach toward the communication device corresponding to the seat selection data 33B transmitted by the transmission control circuit 31E, whereby not only the receiving occupants but also the occupants in the vehicle can see transmission and reception of icons. This contributes to activation of communication between occupants.

A computer program executed by the communication control device in the present embodiment is embedded in advance in a ROM or the like.

The computer program executed by the communication control device in the present embodiment may be provided as a file in an installable or executable format recorded on a computer-readable recording medium such as CD-ROM, flexible disk (FD), CD-R, or digital versatile disk (DVD).

Furthermore, the computer program executed by the communication control device in the present embodiment may be stored on a computer connected to a network such as the Internet and downloaded via the network. The computer program executed by the communication control device in the present embodiment may be provided or distributed via a network such as the Internet.

In the foregoing third embodiment, the communication control device 400 is mounted on the vehicle 1 with four wheels. However, embodiments are not limited to this. The communication control device can be mounted on a movable body having seats on a plurality of rows in the front-to-rear direction, such as bus, airplane, and train.

For the foregoing embodiments, the following A-1 to A-20 and B-1 to B-20 are disclosed.

(A-1)

A vehicle comprising:
a first wheel;
a second wheel;
a body coupled to the first wheel and the second wheel and movable in a predetermined direction of travel by the first wheel and the second wheel, the body having a roof covering a cabin and having an outer surface and an inner surface;
a movement detector set to detect movement of the body in the predetermined direction of travel; and
an illumination circuit disposed on the inner surface of the roof, wherein
the illumination circuit includes at least a first light emitter, a second light emitter, and a third light emitter, and
the first light emitter, the second light emitter, and the third light emitter are disposed along the predetermined direction of travel on the inner surface of the roof, and have a light emission state changed in response to movement of the body along the direction of travel.

(A-2)

The vehicle according to (A-1), wherein the first light emitter, the second light emitter, and the third light emitter have a light emission state changed in response to the movement of the body along the direction of travel and map information.

(A-3)

The vehicle according to (A-2), further comprising a wireless communication unit set to receive the map information from outside.

(A-4)

The vehicle according to (A-1), further comprising an imaging circuit capable of capturing an image of exterior of the body, wherein
an imaging range of the imaging circuit includes a space away from the outer surface of the roof with respect to a ground on which at least one of the first wheel and the second wheel is grounded, and
the first light emitter, the second light emitter, and the third light emitter have a light emission state changed in response to the movement of the body along the direction of travel and an image captured by the imaging circuit.

(A-5)

The vehicle according to (A-4), wherein the first light emitter, the second light emitter, and the third light emitter have a light emission state changed in response to the movement of the body along the direction of travel and an image captured by the imaging circuit before a predetermined period of time.

(A-6)

The vehicle according to (A-5), wherein the predetermined period of time changes in accordance with a speed of movement of the vehicle in a predetermined direction.

(A-7)

The vehicle according to any one of (A-4) to (A-6), wherein the imaging circuit is disposed at an upper front part in the cabin.

(A-8)

The vehicle according to any one of (A-1) to (A-7), wherein each of the first light emitter, the second light emitter, and the third light emitter emits monochromatic light.

(A-9)

The vehicle according to any one of (A-1) to (A-7), wherein each of the first light emitter, the second light emitter, and the third light emitter emits light of multiple colors.

(A-10)

The vehicle according to any one of (A-1) to (A-9), wherein a light emission pattern of the first light emitter, the second light emitter, and the third light emitter changes to flow in a direction opposite to the direction of travel, in response to the movement of the body along the direction of travel.

(A-11)

A vehicle control device comprising:
an acquisition circuit configured to acquire a detection result of a movement detector set to detect movement of a body in a predetermined direction of travel, the body being coupled to a first wheel and a second wheel and having a roof covering a cabin and having an outer surface and an inner surface; and
a control circuit configured to control respective light emission states of at least a first light emitter, a second light emitter, and a third light emitter disposed in a line along the predetermined direction of travel on the inner surface of the roof.

(A-12)

The vehicle control device according to (A-11), wherein the control circuit changes a light emission state for the first light emitter, the second light emitter, and the third light emitter, in response to the movement of the body along the direction of travel and map information.

(A-13)

The vehicle control device according to (A-12), wherein the acquisition circuit acquires the map information received by a wireless communication unit from outside.

(A-14)

The vehicle control device according to (A-11), wherein
the acquisition circuit acquires an image captured by an imaging circuit configured to capture an image of exterior of the body, an imaging range of the imaging circuit including a space away from the outer surface of the roof with respect to a ground on which at least one of the first wheel and the second wheel is grounded, and
the control circuit changes a light emission state for the first light emitter, the second light emitter, and the third light emitter, in response to the movement of the body along the direction of travel and the image captured by the imaging circuit.

(A-15)

The vehicle control device according to (A-14), wherein the control circuit changes a light emission state for the first light emitter, the second light emitter, and the third light emitter, in response to the movement of the body along the direction of travel and an image captured by the imaging circuit before a predetermined period of time.

(A-16)

The vehicle control device according to (A-15), wherein the control circuit changes the predetermined period of time in accordance with a speed of movement of the vehicle in a predetermined direction.

(A-17)

The vehicle control device according to any one of (A-14) to (A-16), wherein the imaging circuit is disposed at an upper front part in the cabin.

(A-18)

The vehicle control device according to any one of (A-11) to (A-17), wherein the control circuit allows each of the first light emitter, the second light emitter, and the third light emitter to emit monochromatic light.

(A-19)

The vehicle control device according to any one of (A-11) to (A-17), wherein the control circuit allows each of the first light emitter, the second light emitter, and the third light emitter to emit light of multiple colors.

(A-20)

The vehicle control device according to any one of (A-11) to (A-19), wherein the control circuit changes a light emission pattern of the first light emitter, the second light emitter, and the third light emitter to flow in a direction opposite to the direction of travel, in response to the movement of the body along the direction of travel.

(B-1)

A vehicle comprising:
a first wheel;
a second wheel;
a body coupled to the first wheel and the second wheel and movable by the first wheel and the second wheel;
a plurality of seats for occupants arranged in the body; and
communication devices for use in communication between the occupants, wherein
the vehicle further comprises:
an icon display control circuit configured to perform control of displaying one or more icons on a display, the icons being used for communication between the occupants;
an icon selection circuit configured to select one icon from among the one or more icons in response to user input;
a seat display control circuit configured to perform control of displaying a seating chart on the display, the seating chart indicating positions of the seats;
a seat selection circuit configured to select a seat serving as a transmission destination of the icon selected by the icon selection circuit from the seating chart, in response to the user input; and
a transmission control circuit configured to transmit the icon to the communication device corresponding to the seat selected by the seat selection circuit.

(B-2)

The vehicle according to (B-1), further comprising a reception control circuit configured to receive the icon onto the communication device corresponding to the seat transmitted by the transmission control circuit, wherein
the seat display control circuit displays the transmitted seat position on the display in accordance with the transmitted seat, and
the icon display control circuit displays the icon on the display in accordance with the transmitted icon.

(B-3)

The vehicle according to (B-1) or (B-2), wherein
the communication devices are arranged in the respective seats, and
the display is provided on an inner wall of the vehicle.

(B-4)

The vehicle according to any one of (B-1) to (B-3), wherein the display at least includes a liquid crystal panel and an electrostatic touch panel.

(B-5)

The vehicle according to any one of (B-1) to (B-4), wherein the display further includes a decorative film on a surface layer.

(B-6)

The vehicle according to (B-5), wherein the decorative film has a wood-grain pattern.

(B-7)

The vehicle according to (B-1) or (B-2), wherein
the communication devices are arranged in front of and between respective front seats, and
the display is provided in an instrument panel of the vehicle.

(B-8)

The vehicle according to (B-7), wherein the display is arranged far from a driver's seat.

(B-9)

The vehicle according to (B-3), wherein
the display further includes light emitters,
the light emitters are arranged between the respective communication devices, and
the vehicle further comprises a light emission control circuit configured to successively turn on the light emitters to approach from the transmitting seat toward the communication device corresponding to the seat transmitted by the transmission control circuit.

(B-10)

The vehicle according to (B-9), wherein
the light emitters are provided on an inner wall of the vehicle, and
each of the light emitters includes a decorative film on a surface layer.

(B-11)

A communication control device mountable on a vehicle,
the vehicle comprising:
a first wheel;
a second wheel;
a body coupled to the first wheel and the second wheel and movable by the first wheel and the second wheel;
a plurality of seats for occupants arranged in the body; and
communication devices each arranged for a corresponding one of the seats, and
the communication control device comprising:
an icon display control circuit configured to perform control of displaying one or more icons on a display, the icons being used for communication between the occupants;
an icon selection circuit configured to select one icon from among the one or more icons in response to user input;
a seat display control circuit configured to perform control of displaying a seating chart on the display, the seating chart indicating positions of the seats;
a seat selection circuit configured to select a seat serving as a transmission destination of the icon selected by the icon selection circuit from the seating chart, in response to the user input; and
a transmission control circuit configured to transmit the icon to the communication device corresponding to the seat selected by the seat selection circuit.

(B-12)

The communication control device according to (B-11), further comprising a reception control circuit configured to receive the icon onto the communication device corresponding to the seat transmitted by the transmission control circuit, wherein
the seat display control circuit displays the transmitted seat position on the display in accordance with the transmitted seat, and
the icon display control circuit displays the icon on the display in accordance with the transmitted icon.

(B-13)

The communication control device according to (B-11) or (B-12), wherein
the communication devices are arranged in the respective seats, and
the display is provided on an inner wall of the vehicle.

(B-14)

The communication control device according to any one of (B-11) to (B-13), wherein the display at least includes a liquid crystal panel and an electrostatic touch panel.

(B-15)

The communication control device according to any one of (B-11) to (B-14), wherein the display further includes a decorative film on a surface layer.

(B-16)

The communication control device according to (B-15), wherein the decorative film has a wood-grain pattern.

(B-17)

The communication control device according to (B-11) or (B-12), wherein
the communication devices are arranged between the respective front seats, and
the display is provided on an inner wall of the vehicle.

(B-18)

The communication control device according to (B-17), wherein the display is arranged far from a driver's seat.

(B-19)

The communication control device according to (B-13), wherein
the display further includes light emitters,
the light emitters are arranged between the respective communication devices, and
the vehicle further comprises a light emission control circuit configured to successively turn on the light emitters to approach from the transmitting seat toward the communication device corresponding to the seat transmitted by the transmission control circuit.

(B-20)

The communication control device according to (B-19), wherein
the light emitters are provided on an inner wall of the vehicle, and
each of the light emitters includes a decorative film on a surface layer.

The effects of the embodiments described herein are examples only and are not limited, and may include other effects.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle comprising:
a first wheel;
a second wheel;
a body coupled to the first wheel and the second wheel, the body being movable by the first wheel and the second wheel;
a first imaging circuit configured to capture an image of exterior of the vehicle; and
a processor configured to:
set a monitoring target;
start, when a monitoring start condition is met, a monitoring process of determining whether the monitoring target belongs to a monitoring range based on a captured image by the first imaging circuit; and
terminate, when a monitoring end condition is met, the monitoring process, the monitoring start condition or the monitoring end condition including a condition related to an operation of the vehicle.

2. The vehicle according to claim 1, wherein the monitoring start condition includes that a parking brake of the vehicle has been applied.

3. The vehicle according to claim 2, wherein the monitoring start condition includes that the vehicle is not locked from outside.

4. The vehicle according to claim 2, wherein the monitoring start condition includes that a door of the vehicle has been opened.

5. The vehicle according to claim 2, wherein the monitoring start condition includes that the monitoring target has been extracted based on the captured image by the first imaging circuit.

6. The vehicle according to claim 1, wherein the monitoring end condition includes that a parking brake of the vehicle has been released.

7. The vehicle according to claim 1, wherein the monitoring end condition includes that the vehicle has been locked from outside.

8. The vehicle according to claim 1, wherein the monitoring process performs a notification process when it is determined that the monitoring target does not belong to the monitoring range based on the captured image by the first imaging circuit.

9. The vehicle according to claim 1, further comprising a second imaging circuit configured to capture an image of interior of the vehicle, wherein
the processor is configured to set the monitoring target based on a captured image by the second imaging circuit and a past captured image by the second imaging circuit.

10. The vehicle according to claim 1, wherein the monitoring range is based on an imaging range of the first imaging circuit.

11. A vehicle control device mountable on a vehicle,
the vehicle comprising:
a first wheel;
a second wheel;
a body coupled to the first wheel and the second wheel, the body being movable by the first wheel and the second wheel; and
a first imaging circuit configured to capture an image of exterior of the vehicle, and
the vehicle control device comprising:
a memory; and
a processor coupled to the memory and configured to:
set a monitoring target based on a captured image;
start, when a monitoring start condition is met, a monitoring process of determining whether the monitoring target belongs to a monitoring range based on a captured image by the first imaging circuit; and
terminate, when a monitoring end condition is met, the monitoring process, the monitoring start condition or the monitoring end condition including a condition related to an operation of the vehicle.

12. The vehicle control device according to claim 11, wherein the monitoring start condition includes that a parking brake of the vehicle has been applied.

13. The vehicle control device according to claim 12, wherein the monitoring start condition includes that the vehicle is not locked from outside.

14. The vehicle control device according to claim 12, wherein the monitoring start condition includes that a door of the vehicle has been opened.

15. The vehicle control device according to claim 12, wherein the monitoring start condition includes that the monitoring target has been extracted based on the captured image by the first imaging circuit.

16. The vehicle control device according to claim 11, wherein the monitoring end condition includes that a parking brake of the vehicle has been released.

17. The vehicle control device according to claim 11, wherein the monitoring end condition includes that the vehicle has been locked from outside.

18. The vehicle control device according to claim 11, wherein the monitoring process performs a notification process when it is determined that the monitoring target does not belong to the monitoring range based on the captured image by the first imaging circuit.

19. The vehicle control device according to claim 11, wherein
the vehicle further comprises a second imaging circuit configured to capture an image of interior of the vehicle, and
the processor is configured to set the monitoring target based on a captured image by the second imaging circuit and a past captured image by the second imaging circuit.

20. The vehicle control device according to claim 11, wherein the monitoring range is based on an imaging range of the first imaging circuit.
